(19) United States
(12) Patent Application Publication
(10) Pub. No.: US 2015/0210039 A1
(43) Pub. Date: Jul. 30, 2015

(54) COMPOSITE MATERIALS

(71) Applicant: Hexcel Composites Limited, Cambridge (GB)

(72) Inventors: Martin Simmons, Baldock (GB); John Ellis, Duxford (GB); John Cawse, Tavistock (GB); George Green, Stapleford (GB)

(21) Appl. No.: 14/625,197

(22) Filed: Feb. 18, 2015

Related U.S. Application Data
(63) Continuation-in-part of application No. 12/221,635, filed on Aug. 5, 2008, now Pat. No. 8,980,770.
Application No. 12/221,635 is a continuation of application No. PCT/GB2007/004220, filed on Nov. 6, 2007.
Application No. PCT/GB2007/004220 is a continuation-in-part of application No. 13/696,721, filed on Nov. 28, 2012.

(30) Foreign Application Priority Data
Nov. 6, 2006 (GB) 0622060.2
Dec. 21, 2010 (EP) 10196345.2

(51) Int. Cl. B32B 5/26; B32B 5/30; B32B 5/16

(52) U.S. Cl. CPC B32B 5/26; B32B 5/16; B32B 5/30; B32B 2250/20; B32B 2260/023; B32B 2260/046; B32B 2262/106; B32B 2264/0214; B32B 2264/0264; B32B 2264/108; B32B 2264/12; B32B 2307/202; B32B 2605/18

(57) ABSTRACT

A prepreg comprising a single structural layer of electrically conductive unidirectional fibres and a first outer layer of curable resin substantially free of structural fibres, and optionally a second outer layer of curable resin substantially free of structural fibres, the sum of the thicknesses of the first and second outer resin layers at a given point having an average of at least 10 micrometres and varying over at least the range of from 50% to 120% of the average value, and wherein the first outer layer comprises electrically conductive particles.

This application is a continuation-in part of co-pending, U.S. application Ser. No. 13/696,721, filed on Nov. 28, 2012, which is a 371 of PCT/EP2011/006433, filed on Dec. 20, 2011. This application also is a continuation-in part of co-pending U.S. application Ser. No. 12/221,635, filed on Aug. 5, 2008, which is a continuation of PCT/GB2007/004220. filed on Nov. 6, 2007.

### BACKGROUND OF THE INVENTION

1. Field of the Invention

The present invention relates to composite materials, and particularly, but not exclusively, to fibre reinforced composite materials.

2. Description of Related Art

Composite materials are increasingly used in structural applications in many fields owing to their attractive mechanical properties and low weight in comparison to metals. Composites are known in the field to consist of layering of materials to provide a structurally advantageous laminate type material. However, whilst electrical conductivity is one of the most obvious attributes of metals, composite materials based on fibre reinforcements (such as adhesive films, surfacing films, and pre-impregnated (prepreg) materials), generally have much lower electrical conductivity.

Conventional composite materials usually consist of a reinforcement phase, generally comprising continuous or discontinuous fibres, and a matrix phase, generally a thermoset or thermoplastic polymer. Most early first generation matrix polymers for the manufacture of composites were, by nature, brittle and it has therefore been necessary to develop more toughened versions. The composites materials used as primary structures in aerospace applications tend to be so-called second or third generation toughened materials.

There is a particular need for composite materials which exhibit electrical conductivity for several applications. These applications include use for protection against lightning strikes, electrostatic dissipation (ESD), and electromagnetic interference (EMI). Prior composite materials, such as those based upon carbon fibres, are known to have some degree of electrical conductivity which is usually associated with the graphitic nature of the carbon filaments. However, the level of electrical conductivity provided is insufficient for protecting the composite Material from the damaging effects of, for example, a lightning strike.

Second generation toughened composites represent an improvement over earlier first generation materials due to incorporation of toughening phases within the matrix material. Various methods for increasing electrical conductivity in these composites have been used. These methods typically include incorporation of metals into the assembly via expanded foils, metal meshes, or interwoven wires. Typical metals which are used for this purpose include aluminium, bronze and copper. These composite materials can provide better electrical conductivity. However, they are generally heavy and have significantly degraded mechanical and aesthetic properties. These composites are usually found at the first one or two plies of the material, and therefore a poor overall surface finish often results.

In the event, of a lightning strike on second generation composites, damage is normally restricted to the surface protective layer. The energy of the lightning strike is typically sufficient to vaporize some of the metal and to burn a small hole in the mesh. Damage to the underlying composite may be minimal, being restricted to the top one or two plies. Nevertheless, after such a strike it would be necessary to cut out the damaged area and make good with fresh metal protection and, if required, fresh composite.

As already mentioned, materials with carbon fibres do possess some electrical conductivity. However, the conductivity pathway is only in the direction of the fibres, with limited ability for dissipation of electrical current in directions orthogonal to the plane of the fibre reinforcement (z direction). Carbon reinforced materials often comprise an interleaf structure which results in inherently low conductivity in the z direction due to the electrical insulation properties of the interleaf. The result of such an arrangement can lead to disastrous effects when damaged by lightning as the electrical discharge can enter the interleaf, volatilize the resin therein, and cause mass delamination and penetration through the composite material.

So-called third generation toughened composite materials are based on interleaf technology where resinous layers are alternated with fibre reinforced plies, and provide protection against impacts. However, these resin layers act as an electrical insulator and therefore electrical conductivity in the z direction of the material is poor (i.e. orthogonal to the direction of the fibres). Lightning strikes on the composite material can result in catastrophic failure of the component, with a hole being punched through a multiple ply laminate.

### SUMMARY OF THE INVENTION

The present invention therefore seeks to provide a composite material which has improved electrical conductivity properties in comparison to prior attempts as described herein, and has little or no additional weight compared to a standard composite material. The present invention also seeks to provide a composite material which has the improved electrical conductivity without detriment to the mechanical performance of the material. The present invention further seeks to provide a method of making the composite material having improved electrical conductivity properties. A further aim is to provide a lightning strike tolerant composite material which is convenient to manufacture, use, and repair.

According to a first aspect of the present invention there is provided a composite material comprising;

i) a first conductive layer comprising a plurality of electrically conductive fibres;

ii) a second conductive layer comprising a plurality of electrically conductive fibres;

iii) a resin layer located between said first conductive fibrous layer and said second conductive fibrous layer, said resin layer comprising non-electrically conductive polymeric resin; and

iv) a plurality of conductive bridges extending between said first conductive fibrous layer and said second conductive fibrous layer wherein each of said conductive bridges consists of a single electrically conductive particle.

According to a second aspect of the present invention there is provided a method of making a composite material comprising the steps of;

i) providing a first conductive layer comprising a plurality of electrically conductive fibres;

ii) providing a second conductive layer comprising a plurality of electrically conductive fibres;

iii) providing a resin layer located, between said first conductive fibrous layer and said second conductive fibrous layer, said resin layer comprising non-electrically conductive polymeric resin; and

iv) providing a plurality of conductive bridges extending between said first conductive fibrous layer and said second conductive fibrous layer wherein each of said conductive bridges consists of a single electrically conductive particle.

According to a third aspect of the present invention electrically conductive nano materials are included in addition to the conductive bridges in order to increase conductance through the resin layer.

Surprisingly, it has been found that use of conducting particles in a polymeric resin of a prepreg forms conductive bridges across the non-conductive resin interleafs or layers to provide reduced bulk resistivity, thereby improving z directional electrical conductivity through the composite material. Additionally, it has been found that the conducting particles dispersed in the resin formulation, and subsequently prepregged result in a prepreg having substantially similar handling characteristics in comparison with an equivalent unmodified prepreg.

Also in accordance with an alternate embodiment of the present invention, it was found that composite materials having resin interleaf layers which vary in their thickness can provide good toughness performance whilst allowing smaller electrically conductive particles to create local regions of electrical conductivity through the interleaf.

Thus, in a first aspect of this alternate embodiment, the invention relates to a prepreg comprising a single structural layer of electrically conductive unidirectional fibres and a first outer layer of curable resin substantially free of structural fibres, and optionally a second outer layer of curable resin substantially free of structural fibres, the sum of the thicknesses of the first and second outer resin layers at a given point having an average of at least 10 micrometres and varying over at least the range of from 50% to 120% of the average value, and wherein the first outer layer comprises electrically conductive particles.

If two such prepregs are laid together, the first outer resin layer of one prepreg, and if present the second outer layer of the other prepreg, form a resin interleaf layer between two layers of electrically conductive unidirectional fibres.

Thus, in a second aspect of the alternate embodiment involving variable interleaf thickness, the invention relates to a composite material comprising a first structural layer of electrically conductive unidirectional fibres, a second structural layer of electrically conductive unidirectional fibres, the first and second layers being separated by an interleaf layer comprising curable resin having an average thickness of at least 10 micrometres, the thickness of the interleaf layer varying over at least the range of from 50% to 120% of the average interleaf layer thickness, and wherein the interleaf layer comprises electrically conductive particles.

The above described and many other features and attendant advantages of the present invention will become better understood by reference to the following detailed description when taken in conjunction with the accompanying drawings.

### BRIEF DESCRIPTION OF THE DRAWINGS

FIG. 1 is a simplified representation of a cross-sectional view (photomicrograph) of a laminate made according to Example 17 wherein 20 μm silver-coated solid glass spheres form conductive bridges that extend across the resin interleave layers and electrically connect adjacent layers of carbon fibres in accordance with the present invention.

FIG. 2 is a simplified representation of a cross-sectional view of a laminate made according to Example 11 wherein 100 μm silver-coated solid glass spheres form conductive bridges across wider resin interleaf layers.

FIG. 3 is an image of a section through a prior art interleaf cured laminate.

FIG. 4 is an image of a section through a cured laminate according to the alternate embodiment of the invention involving variable interleaf thickness.

FIG. 5 is an image of a section through another cured laminate according, to the alternate embodiment of the invention involving variable interleaf thickness.

### DETAILED DESCRIPTION OF THE INVENTION

It is understood that references to a composite material include materials which comprise a fibre reinforcement, where the polymeric resin is in contact with the fibre but not impregnated in the fibre. The term composite material also includes an alternative arrangement in which the resin is partially embedded or partially impregnated in the fibre, commonly known in the art as prepreg. The prepreg may also have a fully impregnated fibrous reinforcement layer. The composite material may also include multilayered materials which have multiple fibre-resin-fibre layers.

It is understood that references to “interleaf structure” refers to the multi-layered material having a fibre-resin-fibre structure. The tern “interleaf” refers to the polymeric resin layer which is present, and interleaved, between the fibre layers. References to “interleaf thickness” or “polymeric resin layer thickness” are to the average distance across the interleaf layer as measured from the uppermost surface of a lower or first fibre ply to a lowermost surface of an upper or second fibre ply. The interleaf thickness is therefore equivalent to the thickness of the interleaved polymeric resin layer, and references to interleaf thickness and polymeric resin layer thickness are interchangeable.

The terms interlayer, interleaf resin layer, resin layer, interplay resin layer, and fibre free layer as used herein are all interchangeable, and refer to the polymeric resin layer.

The term polymeric resin as used herein refers to a polymeric system. The term “polymeric resin” and “polymeric system” are used interchangeably in the present application, and are understood to refer to mixtures of polymers having varying chain lengths. The term polymeric therefore includes an embodiment where the resins present are in the form of a resin mixture comprising any of monomers, dimers, trimers, or prepolymers having chain length greater than 3 monomers. The resulting polymeric resin when cured forms a cross-linked matrix of resin.

Bulk resistivity refers to the measurement of the “bulk” or “volume” resistivity of a semi-conductive material. It can be seen that reference to an “initial bulk resistivity” relates to the bulk resistivity of a polymeric resin prior to addition of conducting particles. The value in Ohms-m is the inherent resistance of a given material. Ohms-m (Ωm) is used for measuring the conductivity of a three dimensional material. The bulk electrical resistivity ρ of a material is usually defined by the following:

$$ρ = \frac{RA}{l}$$

where;

ρ is the static resistivity (measured in ohm metres).

R is the electrical resistance of a uniform specimen of the material (measured in ohms).

l is the length of the specimen (measured in metres)

A is the cross-sectional area of the specimen (measured in square metres)

In the present invention, the volume resistivity is only measured in the z-direction (through the composite material thickness). In every case it is referenced as the “volume” resistivity as the thickness is always taken into consideration in the calculation.

As demonstrated in Comparative Examples 1-5, incorporation of electrically conductive particles into a non-conductive polymeric resin at concentrations of below 20 vol. % has little effect on the electrical resistance of the resin. However, as demonstrated in Comparative Example 6 and Examples 7-15, the same concentration of electrically conductive particles, when located in the resin interleaf layer, provide a large decrease in the bulk resistance of the composite material. This surprising decrease in bulk resistance is believed to be due to the electrically conductive particles becoming oriented in the interleaf layer so as to function as conductive bridges between the fibre layers. The particles do not function as conductive bridges when they are randomly oriented and distributed in the resin alone.

Furthermore, it has been found that addition of conductive nano materials in the interleaf layer provides an additional reduction in resistance that is believed to be due to the nano materials forming interconnections between the various conductive bridges that are formed by the conducting particles.

A further benefit of the invention is an improved thermal conductivity for the prepreg, leading to faster heat up tunes and better dissipation of the heat generated during the cure exotherm. A still further benefit is that the electrical resistance of the composite material is essentially unchanged with variation in temperature.

The reduction in bulk resistivity and improvement in conductivity results in improved lightning strike performance. This improvement achieved by the present invention is therefore surprising in view of the low levels of electrically conductive particles employed, and the high electrical resistivity normally exhibited by the interleaf resin itself.

It is envisaged that the terms “resistivity” and “conductivity” used herein refer to electrical resistivity and electrical conductivity, respectively.

As used herein, the term “particles” refers to discrete three dimensional shaped additives which are distinct, treated as an individual units, and separable from other individual additives, but this does not preclude additives from being in contact with one another. The term embraces the shapes and sizes of electrically conductive particles described and defined herein.

The term “aspect ratio” used herein is understood to refer to the ratio of the longest dimension to the shortest dimension of a three dimensional body. The term is applicable to additives of any shape and size as used herein. Where the term is used in relation to spherical or substantially spherical bodies, the relevant ratio would be that of the largest cross sectional diameter with the smallest cross sectional diameter of the spherical body. It will therefore be understood that a perfect sphere would have an aspect ratio of 1 (1:1). The aspect ratios as specified herein for electrically conductive particles are based on the dimensions of the particles after any metal coating has been applied.

References to the size of the electrically conductive particles are to the largest cross sectional diameter or dimension of the particles. Suitable electrically conductive particles may include, by way of example, spheres, microspheres, dendrites, beads, powders, any other suitable three-dimensional additives, or any combination thereof.

The conductive particles used in the present invention may comprise any suitable conducting particles that are capable of being oriented within the interleaf resin thickness so as to form conductive bridges. It will be understood that this would include any suitable conductive particles capable of reducing bulk resistivity and thereby facilitating electrical conductivity of the composite material. The electrically conductive particles may be selected from metal coated conducting particles, non-metallic conducting particles, or a combination thereof.

The conductive particles are dispersed in the polymeric resin. It is envisaged that the term “dispersed” may include where the conductive particles are present substantially throughout the polymeric resin without being present in a substantially higher concentration in any part of the polymeric resin. Additionally, the term “dispersed” also includes the conductive particles being present in localized areas of polymeric resin if reduced bulk resistivity is only required in specific areas of the composite material.

The metal coated conducting particles may comprise core particles which are substantially covered by a suitable metal. The core particles may be any suitable particles. Suitable particles, by way of example, include those formed from polymer, rubber, ceramic, glass, mineral, or refractory products such as fly ash.

The polymer may be any suitable polymer which is a thermoplastic or thermosetting polymer. The terms ‘thermoplastic polymer’ and ‘thermosetting polymer’ are as characterized herein.

The core particles formed from glass may be any of the types used for making solid or hollow glass microspheres.

Examples of suitable silica containing glass particles include soda glass, borosilicate, and quartz. Alternatively, the glass may be substantially silica free. Suitable silica free glasses include, by way of example, chalcogenide glasses.

The core particles may be porous or hollow or may themselves be a core-shell structure, for example core-shell polymer particles. The core particles may be first coated with an activating layer, adhesion promoting layer, primer layer, semi-conducting layer or other layer prior to being metal coated.

The core particles are preferably hollow particles formed from glass. Use of hollow core particles formed from glass may be advantageous in applications where weight reduction is of particular importance.

Mixtures of the core particles may be used to obtain, for example, lower densities or other useful properties, for instance a proportion of hollow metal coated glass particles may be used with a proportion of metal coated rubber particles to obtain a toughened layer with a lower specific gravity.

Metals suitable for coating the core particles include, by way of example, silver, gold, nickel, copper, tin, aluminium, platinum, palladium, and any other metals known to possess high electrical conductivity.

Multiple layers of metal coatings may be used to coat the core particles, for example gold coated copper, or silver coated copper. Simultaneous deposition of metals is also possible, thereby producing mixed metal coatings.

The metal coating may be carried out by any of the means known for coating particles. Examples of suitable coating processes include chemical vapour deposition, sputtering, electroplating, or electroless deposition.

The metal may be present as bulk metal, porous metal, columnar, microcrystalline, dendritic, or any of the forms known in metal coating. The metal coating ma be smooth, or may comprise surface irregularities such as fibrils, or bumps so as to increase the specific surface area and improve interfacial bonding. However, the surface must be sufficiently regular to provide a solid electrical connection with the fibrous layer.

The metal coating may be subsequently treated with any of the agents known in the art for improving interfacial bonding with the polymeric resin, for example silanes, titanates, and zirconates.

The electrical resistivity of the metal coating, should be preferably less than 3×10⁻⁵ Ωm, more preferably less than 1×10⁻⁷ Ωm, and most preferably less than 3×10⁻⁸ Ωm.

The metal coated conducting particles may be of any suitable shape for example spherical, ellipsoidal, spheroidal, discoidal, dendritic, rods, discs, acicular, cuboid or polyhedral. Finely chopped or milled fibres may also be used, such as metal coated milled glass fibres. The particles may have well defined geometries or may be irregular in shape.

The metal coated conducting particles should possess an aspect ratio of less than 100, preferably less than 10, and most preferably less than 2.

The metal coated conducting particle size distribution may be monodisperse or polydisperse. Preferably, at least 90 of the metal coated particles have a size within the range 0.3 μm to 100 μm, more preferably 1 μm to 50 μm, and most preferably between 5 μm and 40 μm.

The electrically conductive particles may be non-metallic conducting particles. It will be understood that this would include any suitable non-metallic particles not having a metal coating, and capable of reducing bulk resistivity and thereby facilitating electrical conductivity of the composite material.

Suitable non-metallic conducting particles include, by way of example, graphite flakes, graphite powders, graphite particles, graphene sheets, fullerenes, carbon black, intrinsically conducting polymers (ICPs), including polypyrrole, polythiophene, and polyaniline), charge transfer complexes, or any combination thereof.

An example of a suitable combination of non-metallic conducting particles includes combinations of ICPs with carbon black and graphite particles.

The non-metallic conducting particle size distribution may be monodisperse or polydisperse. Preferably, at least 90% of the non-metallic conducting particles have a size be within the range 0.3 μm to 100 μm, more preferably 1 μm to 50 μm, and most preferably between 5 μm and 40 μm.

The electrically conductive particles have a size whereby at least 50% of the particles present in the polymeric resin have a size within 10 μm of the thickness of the polymeric resin layer. In other words the difference between the thickness of the resin layer and the size of the electrically conductive articles is less than 10 μm. Preferably the electrically Conductive particles have a size whereby at least 50% of the particles in the polymeric resin have a size within 5 μm of the thickness of the polymeric resin layer.

The size of at least 50% of the electrically conductive particles is therefore such that they bridge across the interleaf thickness (polymeric resin layer), and the particles are in contact with an upper fibrous reinforcement ply and a lower fibrous reinforcement ply arranged about the polymeric resin layer.

The electrically conductive particles may be present in the range 0.2 vol. % to 20 vol. % of the composite material. More preferably, the conducting particles are present in the range 0.4 vol. % to 15 vol. %. Most preferably, the conducting particles are present in the range 0.8 vol. % to 10 vol. %.

In an alternative embodiment, electrically conductive nano materials may be present in an amount of less than 10 vol. % of the polymeric resin layer to provide supplemental electrical conductivity through the resin layer.

It can be seen that the preferred ranges of the electrically conductive particles are expressed in vol. % as the weight of the particles may exhibit a large variation due to variation in densities.

The electrically conductive particles may be used alone or in any suitable combination.

Without wishing to be unduly bound by theory, it has been found that the benefits of the invention may be conferred due to the conductive particles (either metal coated or non-metallic) acting as electrical conductance bridges across the interleaf thickness (i.e. across the polymeric resin layer and between the layers of fibrous reinforcement), thereby connecting plies of fibrous reinforcement and improving the z directional electrical conductance.

The conductive bridges that are formed when the size of the electrically conductive particles is substantially equal to the interleaf thickness advantageously allows for electrical conductance across the composite material (in the z plane) to be provided at relatively low loading levels of conductive particles. As previously mentioned, these low loading levels of electrically conductive particles are less than would be typically required to make the polymeric resin itself electrically conducting.

The electrically conductive particles therefore facilitate electrical conductivity by lowering the bulk resistivity of the composite material.

The nano materials used in the above mentioned alternate embodiment may comprise carbon nano materials. The carbon nano materials may be selected from carbon nanotubes, and carbon nanofibres. The carbon nano materials may be any suitable carbon nanotubes or carbon nanofibres.

The carbon nano materials may have a diameter in the range 10-500 nm. Preferred carbon nano materials may have a diameter in the range 100 to 150 nm. The carbon nano materials may preferably have a length in the range 1-10 μm.

The carbon nano materials provide additional electrically conducting pathways through the composite material (in the x,y and z planes) by further bridging between the conductive particles and across the interleaf.

The fibrous reinforcements are arranged in the form of layers or plies comprising a number of fibre strands. The composite material comprises at least two fibrous reinforcement plies which are arranged either side of a polymeric resin layer. As well as providing electrical conductivity in the x and y planes of the material, the plies act as supporting layers to the structure of the material, and substantially contain the polymeric resin.

The fibrous reinforcement of the prepreg may be selected from hybrid or mixed fibre systems which comprise synthetic or natural fibres, or a combination thereof. The fibrous reinforcement is electrically conductive, and therefore is formed from fibres which are electrically conductive.

The fibrous reinforcement may preferably be selected from any suitable material such as metallised glass, carbon, graphite, metallised polymer fibres (with continuous or discontinuous metal layers), the polymer of which may be soluble or insoluble in the polymeric resin. Any combination of these fibres may be selected. Mixtures of these fibres with non-conducting fibres (such as fibreglass for example) may also be used.

The fibrous reinforcement is most preferably formed substantially from carbon fibres. The fibrous reinforcement may comprise cracked (i.e. stretch-broken) or selectively discontinuous fibres, or continuous fibres. It is envisaged that use of cracked or selectively discontinuous fibres may facilitate lay-up of the cured composite material prior to being fully cured according to the invention, and improve its capability of being shaped.

The fibrous reinforcement may be in the form of woven, non-crimped, non-woven, unidirectional, or multiaxial textile tapes or tows. The woven form is preferably selected from a plain, satin, or twill weave style. The non-crimped and multiaxial forms may have a number of plies and fibre orientations. Such styles and forms of fibrous reinforcement are well known in the composite reinforcement field, and are commercially available from a number of companies including Hexcel Reinforcements of Villeurbanne, France.

The polymeric resin of the prepreg preferably comprises at least one thermoset or thermoplastic resin. The term ‘thermoset resin’ includes any suitable material which is plastic and usually liquid, powder, or malleable prior to curing and designed to be moulded in to a final form. The thermoset resin may be any suitable thermoset resin. Once cured, a thermoset resin is not suitable for melting and remolding. Suitable thermoset resin materials for the present invention include, but are not limited to, resins of phenol formaldehyde, urea-formaldehyde, 1,3,5-triazine-2,4,6-triamine (Melamine), bismaleimide, epoxy resins, vinyl ester resins, benzoxazine resins, phenolic resins, polyesters, unsaturated polyesters, cyanate ester resins, or any combination thereof. The thermoset resin is preferably selected from epoxide resins, cyanate ester resins, bismaleimide, vinyl ester, benzoxazine, and phenolic resins.

The term ‘thermoplastic resin’ includes any suitable material which is plastic or deformable, melts to a liquid when heated and freezes to a brittle, and forms a glassy state when cooled sufficiently. Once formed and cured, a thermoplastic resin is suitable for melting and re-moulding. Suitable thermoplastic polymers for use with the present invention include any of the following either alone or in combination: polyether sulphone (PES), polyether ethersulphone (PEES), polyphenyl sulphone, polysulphone, polyester, polymerisable macrocycles (e.g. cyclic butylene terephthalate), liquid crystal polymers, polyimide, polyetherimide, aramid, polyamide, polyester, polyketone, polyetheretherketone (PEEK), polyurethane, polyurea, polyarylether, polyarylsulphides, polycarbonates, polyphenylene oxide (PPO) and modified PPO, or any combination thereof.

The polymeric epoxy resin preferably comprises at least one of bisphenol-A (BPA) diglycidyl ether and bisphenol-F (BPF) diglycidyl ether and derivatives thereof tetraglycidyl derivative of 4,4′-diaminodiphenylmethane (TGDDM); triglycidyl derivative of aminophenols, and other glycidyl ethers and glycidyl amines well known in the art.

The polymeric resin is applied to the fibrous reinforcement. The fibrous reinforcement may be fully or partially impregnated by the polymeric resin. In an alternative embodiment, the polymeric resin may be a separate layer which is proximal to, and in contact with, the fibrous reinforcement, but does not substantially impregnate said fibrous reinforcement.

The composite material may include at least one curing agent. The curing agent may be substantially present in the polymeric resin. It is envisaged that the term “substantially present” means at least 90 wt. % of the curing agent, preferably 95 wt. % of the curing agent.

For epoxy resins, the curing agents of the invention are those which facilitate the curing of the epoxy-functional compounds of the invention, and, particularly, facilitate the ring opening polymerisation of such epoxy compounds. In a particularly preferred embodiment, such curing agents include those compounds which polymerise with the epoxy-functional compound or compounds, in the ring opening polymerisation thereof.

Two or more such curing agents may be used in combination. Suitable curing agents include anhydrides, particularly polycarboxylic anhydrides, such as nadic anhydride (NA), methylnadic anhydride, phthalic anhydride, tetrahydrophthalic anhydride, hexahydrophthalic anhydride, methyltetrahydrophthalic anhydride, methylhexahydrophthalic anhydride, endomethylenetetrahydrophthalic anhydride, or trimellitic anhydride. Further suitable curing agents are the amines, including aromatic amines, e.g. 1,3-diaminobenzene, 1,4-diaminobenzene, 4,4′-diaminodiphenylmethane, and the polyaminosulphones, such as 4,4′-diaminodiphenyl sulphone (4,4′-DDS), and 3,3′-diaminodiphenyl sulphone (3,3′-DDS). Also, suitable curing agents may include phenol-formaldehyde resins, such as the phenol-formaldehyde resin having an average molecular weight of about 550-650, the p-t-butylphenol-formaldehyde resin having an average molecular weight of about 600-700, and the p-n-octylphenol-formaldehyde resin, having an average molecular weight of about 1200-1400.

Yet further suitable resins containing phenolic groups can be used, such as resorcinol based resins, and resins formed by cationic polymerisation, such as dicyclopentadiene-phenol copolymers. Still additional suitable resins are melamine-formaldehyde resins, and urea-formaldehyde resins.

Different commercially available compositions may be used as curing agents in the present invention. One such composition is AH-154, a dicyandiamide type formulation, available from Ajinomoto USA Inc. Others which are suitable include Ancamide 1284. which is a mixture of 4,4′-methylenedianiline and 1,3-benzenediamine; these formulations are available from Pacific Anchor Chemical. Performance Chemical Division, Air Products and Chemicals, Inc., Allentown, USA.

The curing agent (s) is selected such that it provides curing of the resin component of the composite material when combined therewith at suitable temperatures. The amount of curing agent required to provide adequate curing of the resin component will vary depending upon a number of factors including the type of resin being cured, the desired curing temperature, and the curing time. Curing agents typically include cyanoguanidine, aromatic and aliphatic amines, acid anhydrides, Lewis Acids, substituted ureas, imidazoles and hydrazines. The particular amount of curing agent required for each particular situation may be determined by well-established routine experimentation.

Exemplary preferred curing agents include 4,4′-diaminodiphenyl sulphone (4,4′-DDS) and 3,3′-diaminodiphenyl sulphone (3,3′-DDS). The curing agent, if present, may be present in the range 45 wt. % to 2 wt. % of the composite material. More preferably, the curing agent may be present in the range 30 wt. % to 5 wt. %. Most preferably, the curing agent may be present in the range 25 wt. % to 5 wt. %.

Accelerators, if present, are typically urones. Suitable accelerators, which may be used alone or in combination include N,N-dimethyl, N′-3,4-dichloiphenyl urea (Diuron). N′-3-chlorophenyl urea (Monuron), and preferably N,N-(4-methyl-m-phenvIene bis[N′,N′-dimethylurea] (TDI urone).

The composite material may also include additional ingredients such as performance enhancing or modifying agents. The performance enhancing or modifying agents, by way of example, may be selected from flexibilisers, toughening agents/particles, additional accelerators, core shell rubbers, flame retardants, wetting agents, pigments/dyes, flame retardants, plasticisers, UV absorbers, anti-fungal compounds, fillers, viscosity modifiers/flow control agents, tackifiers, stabilisers, and inhibitors.

Toughening agents/particles may include, by way of example, any of the following either alone or in combination: polyamides, copolyamides, polyimides, aramids, polyketones, polyetheretherketones, polyarylene ethers, polyesters, polyurethanes, polysulphones, high performance hydrocarbon polymers, liquid crystal polymers, PTFE, elastomers, and segmented elastomers.

Toughening agents/particles, if present, may be present in the range 45 wt. % to 0 wt. % of the composite material. More preferably, they may be present in the range 25 wt. % to 5 wt. %. Most preferably, they may be present in the range 15 wt. % to 10 wt. %.

A suitable toughening agent/particle, by way of example, is Sumikaexcel 5003P, which is commercially available from Sumitomo Chemicals of Tokyo, Japan. Alternatives to 5003P are Solvay polysulphone 105P, and Solvay 104P which are commercially available from Solvay of Brussels, Belgium.

Suitable fillers may include, by way of example, any of the following either alone or in combination: silicas, aluminas, titania, glass, calcium carbonate, and calcium oxide.

The composite material may comprise an additional polymeric resin which is at least one thermoset or thermoplastic resins as defined previously.

Whilst it is desirable that the majority of electrically conductive particles are located within the polymeric resin of the composite material, it is not generally detrimental if a small percentage of such particles are distributed within the fibrous reinforcement. The conducting particles may be suitably dispersed within the polymeric resin of the prepreg by conventional mixing or blending operations.

The mixed resin containing all the necessary additives and the conducting particles can be incorporated into prepreg by any of the known methods, for example a so-called lacquer process, resin film process, extrusion, spraying, printing or other known methods.

In a lacquer process all the resin components are dissolved or dispersed in a solvent and the fibrous reinforcement is dipped in the solvent, and the solvent is then removed by heat. In a resin film process the polymeric resin is cast as a continuous film, either from a lacquer or a hot melt resin, onto a substrate which has been treated with a release agent, and then the coated film is contacted against the fibrous reinforcement and, under the aid of heat and pressure, the resin film melts and flows into the fibres. A multiplicity of films may be used and one or both sides of the fibre layer may be impregnated in this way.

If the prepreg is made by a film or lacquer process, the majority of the conducting particles will be “filtered” by the reinforcing fibres and thus will be substantially prevented from entering the fibrous reinforcement because the particle size is larger than the distance between the reinforcing fibres. Accordingly, the particles become concentrated in the interleaf layer where they act as individual spacers or bridges between the fibrous layers. Other processes, such as spraying or printing would enable the conducting particles to be placed directly onto the fibrous reinforcement with very low penetration of the said particles between the fibres.

When metal coated hollow particles are used, it may be necessary to utilize lower shear mixing equipment to reduce the deforming effect that mixing may produce on the conducting particles.

The prepreg may be in the form of continuous tapes, towpregs, fabrics, webs, or chopped lengths of tapes, towpregs, fabrics, or webs. The prepreg may be an adhesive or surfacing film, and may additionally have embedded carriers in various forms both woven, knitted, and non-woven.

Prepregs formulated according to the present invention may be fabricated into final components using any of the known methods, for example manual lay-up, automated tape lay-up (ATL), automated fibre placement, vacuum bagging, autoclave cure, out of autoclave cure, fluid assisted processing, pressure assisted processes, matched mould processes, simple press cure, press-chive cure, or continuous band pressing.

The composite material may be in an embodiment comprising a single ply of conductive fibrous reinforcement, which has applied on one side a polymeric resin layer comprising electrically conductive particles. The composite material may be manufactured in a single ply embodiment and subsequently be formed in to multiple layers to provide an interleaf structure by lay-up. The interleaf structure is therefore formed during lay-up where a fibre-resin-fibre configuration arises.

The composite material may therefore comprise a single prepreg. Alternatively, the composite material may comprise a plurality of prepregs. The polymeric resin layer thickness of the prepreg is preferably in the range 1 μm to 100 μm, more preferably 1 μm to 50 μm, and most preferably 5 μm to 50 μm.

Multiple layers of conductive composite materials may be used. Thus, by way of example, an assembly may be prepared using 12 plies of standard composite materials, and 4 plies of composite materials comprising conducting particles of the present invention, thus enhancing the conductivity of the final assembly. As a further example, a laminate assembly could be prepared from 12 plies of standard composite materials, and composite material comprising conducting particles and with no carbon fibre reinforcement. Optionally, where a composite material of the present invention is used, an electrically isolating layer can be placed between the carbon fibre plies and the resin surface. For example, a glass reinforced fibrous layer can be used as the isolating layer. It is understood that there are many possible assemblies that could be used, and those described herein are by way of example only.

A further benefit is that the composite material of the present invention, prior to being fully cured, is completely flexible and is suitable for automated tape lay up processes which are increasingly used in the manufacture of large composite structures in the aerospace industry.

The composite material of the invention may be fully or partially cured using any suitable temperature, pressure, and time conditions known in the art. The composite material may be cured using a method selected from UV-visible radiation, microwave radiation, electron beam, gamma radiation, or other suitable thermal or non-thermal radiation.

Thus, according to a fourth aspect of the present invention there is provided a method of making a cured composite material comprising the steps of the second aspect, and subsequently curing the composite material. The curing step of the fourth aspect may be using any known method. Particularly preferred are curing methods as described herein.

Thus according to a fifth aspect of the present invention there is provided a cured composite material which comprises a composite material according to the first aspect of the present invention, wherein the composite material is cured.

Whilst most of the following discussion concentrates on lightning strike protection, it will readily be seen that there are many potential applications for a composite material exhibiting reduced bulk resistivity and high electrical conductivity. Thus, the level of conductivity achieved by the present invention will make the resulting composite materials suitable for use in electromagnetic shielding, electrostatic protection, current return, and other applications where enhanced electrical conductivity is necessary.

Furthermore, although much of the discussion centres around aerospace components, it is also possible to apply the present invention to lightning strike and other electrical management problems in wind turbines, buildings, marine craft, trains, automobiles and other areas of concern.

It is envisaged that the present invention, when used for aerospace components, can be used for primary structure applications (i.e. those parts of the structure which are critical for maintaining the integrity of the airplane), as well as secondary structure applications.

Thus, according, to a sixth aspect of the present invention there is provided a process for making an aerospace article formed from a cured composite material comprising the steps of:
making a cured composite material in accordance with the method of the fourth aspect
using the cured composite material to produce an aerospace article by a known method.

Thus, according to a seventh aspect of the present invention there is provided an aerospace article comprising the cured composite material of the fifth aspect.

All of the features described herein may be combined with any of the above aspects, in any combination.

In the following examples, “neat resin” refers to the basic polymeric matrix resin, in the absence of reinforcing fibres, used for manufacturing prepreg.

M21 is a thermoplastic-toughened epoxy resin that is used in the production of HexPly® M21. M21 includes a mixture of bifunctional, trifunctional and tetrafunctional epoxies that is toughened with a thermoplastic toughening agent. HexPly® M21 is an interleaved prepreg material available from Hexcel Composites, Duxford, Cambridge, United Kingdom.

LY1556 is an epoxy resin available from Huntsman Advanced Materials, Duxford, Cambridge, United Kingdom.

It will be understood that all tests and physical properties listed have been determined at atmospheric pressure and room temperature (i.e. 20° C.), unless otherwise stated herein, or unless otherwise stated in the referenced test methods and procedures.

### COMPARATIVE EXAMPLE 1

### Neat Resin

A neat epoxy resin sample of M21 was produced by blending the epoxy resins, curing agent and toughening agent uniformly and curing in a thermostatically controlled oven at 180° C. for 2 hours. Surface resistivity was then measured for the cured resin plaque using a model 272 resistivity meter from Monroe Electronics by placing a circular electrode on the surface of the neat resin specimen a reading the measured and displayed value on the instrument panel. It is important that contact between the specimen and probe is good, and therefore neat resin samples should be flat, smooth and uniform. Results are shown in Table 1.

### COMPARATIVE EXAMPLE 2

### Neat Resin with Conductive Particles

Samples of resin (M21) comprising silver coated solid glass spheres (size 20 μm) present at the following levels:

2-1 1.0 vol. % (equivalent to 7.5 wt. %)

2-7 7.0 vol. % (equivalent to 5.0 wt. %)

2-3 3.0 vol. % (equivalent to 7.5 wt. %)

2-4 2-4 4.0 vol. % (equivalent to 10.0 wt. %)

were prepared and cured in an oven at 180° C. for 2 hours. Surface resistivity was then measured using the same resistivity meter and procedure as detailed in Example 1. Results are shown in Table 1.

### COMPARATIVE EXAMPLE 3

### Neat Resin with Conductive Particles

Samples of resin (M21) comprising silver coated polymethylmethacrylate (PMMA) particles (size 20 μm) present at the following levels:

3-1 2.5 vol. % (equivalent to 2.5 wt. %)

3-2 5.0 vol. % (equivalent to 5.0 wt. %)

3-3 7.5 vol. % (equivalent to 7.5 wt. %)

3-4 10.0 vol. % (equivalent to 10.0 wt. %)

were prepared and cured in an oven at 180° C. for 2 hours. Surface resistivity was then measured using a resistivity meter and procedure as detailed in Comparative Example 1. Results are shown in Table 1.

### COMPARATIVE EXAMPLE 4

### Neat Resin with Conductive Particles

Samples of M21 epoxy resin comprising silver coated hollow glass spheres (size 20 μm) present at the following levels:

4-1 2.5 vol. % (equivalent to 2.5 wt. %)

4-2 5.0 vol. % (equivalent to 5.0 wt. %)

4-3 7.5 vol. % (equivalent to 7.5 wt. %)

4-4 10.0 vol. % (equivalent to 10.0 wt. %)

were prepared and cured in an oven at 180° C. for 2 hours. Surface resistivity was then measured using a resistivity meter and procedure detailed in Comparative Example 1. Results are shown in Table 1.

The surface resistivity is a measure of resistivity of thin films having uniform thickness. Surface resistivity is measured in ohms/square (Ω/sq.), and it is equivalent to resistivity for two-dimensional systems. The term is therefore a measure of resistivity for a current passing along the surface, rather than through the material which is expressed as bulk resistivity. Surface resistivity is also referred to as sheet resistance.

TABLE 1
Surface resistivity of M21epoxy resin
modified with conductive particles.

| | | | | Surface |
|---|---|---|---|---|
| | | Loading | Loading | Resistivity |
| Example | Conductive additive | (vol. %) | (wt. %) | (Ω/square) |
| 1 | No additive | 0 | 0 | 2.0 × 10¹² |
| 2-1 | Silver coated solid glass | 1.0 | 2.5 | 3.4 × 10¹² |
| | spheres | | | |
| 2-2 | Silver coated solid glass | 2.0 | 5.0 | 3.0 × 10¹² |
| | spheres | | | |
| 2-3 | Silver coated solid glass | 3.0 | 7.5 | 2.5 × 10¹² |
| | spheres | | | |
| 2-4 | Silver coated solid glass | 4.0 | 10.0 | 2.6 × 10¹² |
| | spheres | | | |
| 3-1 | Silver coated PMMA particles | 2.5 | 2.5 | 2.4 × 10¹² |
| 3-2 | Silver coated PMMA particles | 5.0 | 5.0 | 3.0 × 10¹² |
| 3-3 | Silver coated PMMA particles | 7.5 | 7.5 | 1.8 × 10¹² |
| 3-4 | Silver coated PMMA particles | 10.0 | 10.0 | 1.7 × 10¹² |
| 4-1 | Silver coated hollow glass | 2.5 | 2.5 | 2.7 × 10¹² |
| | spheres | | | |
| 4-2 | Silver coated hollow glass | 5.0 | 5.0 | 2.8 × 10¹² |
| | spheres | | | |
| 4-3 | Silver coated hollow glass | 7.5 | 7.5 | 1.8 × 10¹² |
| | spheres | | | |
| 4-4 | Silver coated hollow glass | 10.0 | 10.0 | 1.9 × 10¹² |
| | spheres | | | |

These results demonstrate that addition of conductive silver particles at 10 vol. % or lower provides little, if any, reduction in the surface resistivity of cured neat epoxy resin. The epoxy resin remains essentially non-electrically conductive (at least 1×10¹² Q/square) even though conducting particles have been added.

### COMPARATIVE EXAMPLE 5

### Neat Resin with Carbon Nano Fibres

A neat epoxy resin sample was produced in which LY1556 (50.0 g) was added carbon nanofibres (110 nm-150 nm diameter having lengths of 1-10 μm) as produced by Electrovac of Austria. Using a Flaktec Speedmixer the fibres were dispersed in the resin at 2500 rpm for 15 minutes. Silver coated glass beads (20 μm) at 2.0 vol. %, carbon nanofibres at 2.0 wt. %, and 4,4-diaminodiphenylsulphone were added to the mixture and blended by stirring. The resistivity of neat LY1556 resin is about 10¹² Q/square. The formulation was cured in a thermostatically controlled oven at 180° C. for 2 hours. Surface resistivity was then measured for the cured plaque using a model 272 resistivity meter from Monroe Electronics. Results are summarised in Table 2.

TABLE 2
Surface resistivity of epoxy resin modified with silver
coated glass spheres and carbon nanofibres (CNF).

| | 110 nm | Silver solid | Silver coated | Surface |
|---|---|---|---|---|
| | CNFs | glass spheres | glass spheres | Resistivity |
| Example | (wt. %) | (vol. %) | (wt. %) | (Ω/square) |
| 1 | — | — | — | 2 × 10¹² |
| 2-2 | — | 2.0 | 5.0 | 3.0 × 10¹² |
| 5 | 2 | 2.0 | 5.0 | 4.7 × 10² |

These results show that the combination of carbon nanofibres with silver coated glass spheres lowers the surface resistivity of the epoxy resin when compared to the neat epoxy resin and epoxy resin that contains silver coated solid glass spheres.

In the following examples, “carbon composite” refers to the basic matrix resin, in the presence of reinforcing carbon fibres, used for manufacturing prepreg.

### COMPARATIVE EXAMPLE 6

### Carbon Composite

M21 resin was produced by blending the components in a Z-blade mixer (Winkworth Machinery Ltd, Reading, England). The resin was coated as a thin film on silicone release paper which was then impregnated on intermediate modulus IM7 unidirectionally oriented carbon fibre available from (Hexcel Composites, Duxford, UK) at a resin weight of 35% using a hot press to make a unidirectional prepreg. A five ply prepreg was laid up unidirectionally which was approximately 10 cm by 10 cm and cured on a vacuum table at a pressure of 7 bar at 177° C. for 2 hours. A z-direction electrical resistance value of the composite was determined first by gold sputtering a square on either side of a rectangular shaped sample in order to ensure low contact resistance. Resistivity was then measured by applying probes to the gold sputtered area of the specimens and using a power source (TTi EL302P Programmable 30V/2 A Power Supply Unit, Thurlby Thandar Instruments, Cambridge, UK) that was capable of varying either voltage or current.

### EXAMPLE 7

### Carbon Composite with Conductive Particles

M21 resin was modified with silver coated solid glass spheres (20 μm) at a range of 0.8-2.4 vol. % of the resin and the components were blended in a Winkworth mixer. The resin was coated as a thin film on silicone release paper and was then impregnated on intermediate modulus IM7 carbon fibre at a resin weight of 35% using a hot press to make a unidirectional prepreg. A five ply prepreg of approximately 10 cm by 10 cm was laid up unidirectionally and cured on a vacuum table at a pressure of 7 bar at 177° C. for 2 hours. A z-direction electrical resistance value was determined according to the method of Example 1. Results are summarised in Table 3.

TABLE 3
Volume resistivity of carbon composite modified
with silver coated glass spheres.

| | | | Z-direction |
|---|---|---|---|
| | Silver coated | Silver coated | volume |
| | glass spheres | glass spheres | resistivity |
| Example | (vol. %) | (wt. %) | (Ωm) |
| 6 | — | — | 3.66 |
| 7-1 | 0.8 | 2 | 2.13 |
| 7-2 | 1.6 | 4 | 1.89 |
| 7-3 | 2.4 | 6 | 1.75 |

The results in Table 3 clearly show a decrease in z-direction volume resistivity when compared to a neat resin material of Example 6. The resistivity is thither reduced when the amount of silver coated glass spheres is increased in the material.

### EXAMPLE 8

### Carbon Composite with Conductive Particles

M21 resin was modified with silver coated hollow glass spheres (20 μm) at a range of 2.5-10.0 vol. % of the resin, and the components were blended in a Winkworth mixer. The resin as coated as a thin film on silicone release paper and was then impregnated on intermediate modulus IM7 carbon fibre at a resin weight of 35% using a hot press to make a unidirectional prepreg. A five ply prepreg of approximately 10 cm by 10 cm was laid up unidirectionally and cured on a vacuum table at a pressure of 7 bar at 177° C. for 2 hours. A z-direction electrical resistance value was determined according to the method of Example 6. Results are summarised in Table 4.

TABLE 4
Volume resistivity of carbon composite modified with silver
coated hollow glass spheres according to Example 8.

| | Silver coated | Silver coated | Z-direction |
|---|---|---|---|
| | hollow glass | hollow glass | volume |
| | spheres | spheres | resistivity |
| Example | (vol. %) | (wt. %) | (Ωm) |
| 8-1 | 2.5 | 2.5 | 0.116 |
| 8-2 | 5.0 | 5.0 | 0.064 |
| 8-3 | 7.5 | 7.5 | 0.032 |
| 8-4 | 10.0 | 10.0 | 0.019 |

The results in Table 4 clearly show a decrease in z-direction volume resistivity. The resistivity is further reduced with increases in the amount of silver coated hollow glass spheres in the material.

### EXAMPLE 9

### carbon Composite with Conductive Particles

M21 resin was modified with silver coated polymethylmethacrylate particles (20 μm) at a range of 2.5-10.0 vol. % of the resin. The resin was produced by blending the componems in a Winkworth mixer. The resin was coated as a thin film on silicone release paper and was then impregnated on intermediate modulus IM7 carbon fibre at a resin weight of 35 using a hot press to make a unidirectional prepreg. A five ply prepreg of approximately 10 cm by 10 cm was laid up unidirectionally and cured on a vacuum table at a pressure of 7 bar at 177° C. for 2 hours. A z-direction electrical resistance value was determined according to the method of Example 6. Results are summarised in Table 5.

TABLE 5
Volume resistivity of carbon composite modified
with silver coated PMMA spheres.

| | | | Z-direction |
|---|---|---|---|
| | Silver coated | Silver coated | volume |
| | PMMA particles | PMMA particles | resistivity |
| Example | (vol. %) | (wt. %) | (Ωm) |
| 9-1 | 2.5 | 2.5 | 0.567 |
| 9-2 | 5.0 | 5.0 | 0.103 |
| 9-3 | 7.5 | 7.5 | 0.110 |
| 9-4 | 10.0 | 10.0 | 0.052 |

The results in Table 5 clearly show a decrease in z-direction volume resistivity. The resistivity is further reduced with increases in the amount of silver coated glass spheres in the material.

### COMPARATIVE EXAMPLE 10

### Carbon Composite with Dendritic Conductive Particles

M21 resin was modified with dendritic silver/copper (40 μm) at a loading of 0.30 vol. % of the resin. The resin was produced by blending the components in a Winkworth mixer. The resin was coated as a thin film on silicone release paper and was then impregnated on intermediate modulus IM7 carbon fibre at a resin weight of 35% using a hot press to make a unidirectional prepreg. A five ply prepreg of approximately 10 cm by 10 cm was laid up unidirectionally and cured on a vacuum table at a pressure of 7 bar at 177° C. for 2 hours. A z-direction electrical resistance value was determined according to the method of Example 6. Results are summarised in Table 6.

### EXAMPLE 11

### Carbon Composite with Conductive Particles

M21 resin was modified with silver coated solid glass beads (100 μm) at a loading of 1.0 vol. % of the resin. A prepreg and composite was produced according to example 9. Z-direction electrical resistance value was determined as per Example 6. Results are summarised in Table 6.

### EXAMPLE 12

### Carbon Composite

M21 resin was modified with silver coated glass fibres (10 μm diameter×190 μm long) at a loading of 1.25 wt. % of the resin. A prepreg and composite was produced according to example 9. Z-direction electrical resistance value was determined as per Example 6. Results are summarised in Table 6.

TABLE 6
Volume resistivity of carbon composite modified
with different conducting particles.

| | | | | Z-direction |
|---|---|---|---|---|
| | | | | volume |
| | Conducting | Particles | Particles | resistivity |
| Example | particle | (vol. %) | (wt. %) | (Ωm) |
| 10 | Dendritic | 0.30 | 2.5 | 12.26 |
| | silver/copper | | | |
| | (40 μm) | | | |
| 11 | Silver coated | 1.0 | 2.5 | 1.10 |
| | glass beads | | | |
| | (100 μm) | | | |
| 12 | Silver coated | 1.25 | 2.5 | 2.89 |
| | glass fibres | | | |
| | (190 μm) | | | |

The results in Table 6 show a decrease in z-direction volume resistivity when spherically shaped (aspect ratio of 1) conductive particles (100 μm) are used. In addition, when conductive particles (silver coated glass fibres) having a relatively high aspect ratio of 19 are used, the resistivity is only modestly reduced. According, a previously mentioned, the aspect ratios for conductive particles are preferably below 10 and more preferably below 2.

### COMPARATIVE EXAMPLE 13

### Carbon Composite-Quasi-Isotropic Laminate

M21 prepreg was produced according to Example 12, except that the layers of unidirectional fibres were oriented in +45′ to each other to form a 6 ply quasi-isotropic (QI) laminate of approximate size 10 cm×10 cm, which was cured on a vacuum table at a pressure of 7 bar at 177° C. for 2 hours. The glass transition temperature, T_{g}, of the QI composite was determined by dynamic thermal analysis from the storage modulus trace, E′, to be 194.5° C. A square sample (3.9 cm×3.9 cm×0.16 cm) was cut from the cured panel and the z-direction resistivity measured as follows. To ensure good electrical contact, the appropriate parts of the composite were vacuum coated with gold in the vicinity where connection was to be made with the power supply. The resistivity was then determined by applying a current of 1 amp from the power supply and measuring the resulting voltage.

TABLE 7
Volume resistivity of the QI composite
of Comparative Example 13.

| | | Z-direction |
|---|---|---|
| | | Volume |
| | | Resistivity |
| Direction | Lay up and size | (Ωm) |
| z | QI | 19.70 |
| | (3.9 cm × 3.9 cm × 0.16 cm) | |

### EXAMPLE 14

### QI Carbon Composite with Conductive Particles

M21 resin was modified with 20 μm silver coated glass beads at (2 vol. %, 5 wt. %) and prepreg was produced according to the method of Example 13. A 6 ply quasi-isotropic laminate of approximate size 10 cm×10 cm was prepared and cured on a vacuum table at a pressure of 7 bar at 177° C. for 2 hours. The glass transition temperature (T_{g}) of the composite was determined as for Comparative Example 13 to be 196.0° C. Thus the addition of the silver coated heads does not have a deleterious effect on the T_{g}. A square sample (3.8 cm×3.8 cm×0.16 cm) was cut from the cured panel and the z-direction resistivity measured as for Example 13. As shown in Table 8, resistivity was significantly improved.

TABLE 8
Volume resistivity of the composite of Example 14.

| | | Z-direction |
|---|---|---|
| | | Volume |
| | | Resistivity |
| Direction | Lay up and size | (Ωm) |
| z | QI | 0.024 |
| | (3.8 cm × 3.8 cm × 0.16 cm) | |

### EXAMPLE 15

### QI Carbon Composite with Conductive Particles and Nano Material

M21 resin was modified with 20 μm silver coated glass beads at (2 vol. %, 5 wt. %) and carbon nanofibres (150 nm diameter and lengths of 1-10 μm) at 2 wt. % of the resin. Prepreg was produced according to Comparative Example 13. A 12 ply quasi-isotropic laminate of approximate size 10 cm×10 cm was prepared and cured on a vacuum table at a pressure of 7 bar at 177° C. for 2 hours. The glass transition temperature (T_{g}) of the composite was determined as for Comparative Example 13 to be 196.5° C. Thus the addition of the silver coated beads has not had a deleterious effect on the T_{g}. A square sample was cut from the cured panel and the z-direction resistivity measured as for Comparative Example 13. As is shown in Table 9, resistivity is significantly reduced in comparison to the QI laminate without conductive particles and nano fibres.

TABLE 9
Volume resistivity of the composite of Example 15.

| | | Z-direction |
|---|---|---|
| | | Volume |
| | | Resistivity |
| Direction | Lay up and size | (Ωm) |
| z | QI | 0.023 |
| | (3.8 cm × 3.8 cm × 0.16 cm) | |

### COMPARATIVE EXAMPLE 16

### Simulated Lightning Strikes with No Conductive Particles

M21 resin was produced using a Winkworth mixer and then filmed onto silicone release paper. This resin film was then impregnated onto unidirectional intermediate modulus carbon fibre, using a pilot scale unidirectional prepregger, which produced a prepreg with an areal weight of 268 g/m² at 35 wt. % of resin. Two six-ply prepregs were produced (lay up +0/90) which were approximately 60 cm by 6.0 cm and these were cured on a vacuum table at a pressure of 7 bar at 177° C. for 2 hours.

The two panels were tested according to procedures established for Zone 1A surfaces, which include surfaces of the aeroplane for which there is a high probability of initial lightning flash attachment (entry or exit) with low probability of flash hang on, such as radomes and leading edges. Zone 1A also includes swept leaders attachment areas. The zone 1A test has three waveform components, high current component A (2×10⁶A. <500 μs), intermediate current component B (average 2 kA, <5 ms) and continuing current component C (200 C, <1 s). Both surfaces of the panels were abraded around the edges to ensure a good connection to the outer frame. The electrode was connected to the panel via a thin copper wire. The copper wire provides a path for the current and vaporises on test. It is needed as the voltage generated is not enough to break down the air.

After a simulated lightning strike, Each of the test panels, which did not comprise metal coated particles, showed severe damage on both the upper surface and lower surface.

An Ultrasonic c-scan was also performed. The Ultrasonic C-scan of the damaged panels was performed using an R/D Tech Omniscan MX from Olympus. The scan showed that the damage area for the unmodified panels was very large.

TABLE 10
Test parameters of lightning strike
tests for Comparative Example 16.

| | A Component | Action | B Component | |
|---|---|---|---|---|
| Panel | Current, I | Integral, | current, I | C Component |
| No. | (kA) | AI (10⁶ A²s) | (kA) | Charge, Q |
| 1 | 191.7 | 2.04 | 1.74 | 31.3 |
| 2 | 191.7 | 2.04 | 1.72 | 24.3 |

TABLE 11
Description of damaged area after lightning strike tests

| Panel | |
|---|---|
| No. | Description of Damage |
| 1 | Upper surface; delamination and dry fibres. |
| | Unusual scorch mark on surface. 330 mm × 250 mm |
| | Bottom surface; delamination and dry fibres. |
| | 420 mm × 230 mm. Hole through panel. |
| 2 | Upper surface; delamination and dry fibres. |
| | 280 mm × 270 mm. |
| | Bottom surface; delamination and dry fibres. |
| | 510 mm × 180 mm |

A large white area was observed on the c-scan. This is where the delamination of the panels had occurred after the simulated lightning strike test. This shows that the damaged area is large for panels that do not include metal coated particles.

### EXAMPLE 17

### Simulated Lightning Strikes with Conductive Particles

M21 resin was modified with 20 μm silver coated glass spheres (2 vol. %, 5 wt. % of resin), blended using a Winkworth mixer and then filmed onto silicone release paper. This resin film was then impregnated onto unidirectional intermediate modulus carbon fibre which produced a prepreg with an areal weight of 268 g/m² at 35 wt. % of resin. Two six-ply prepregs were produced (lay up ±0/90) which were approximately 60 cm by 60 cm and were cured on a vacuum table at a pressure of 7 bar at 177° C. for 2 hours. A lightning strike test was then carried out on each panel according to the method of Comparative Example 16.

The simulated lightning strikes did not penetrate the modified composite panels.

An Ultrasonic c-scan was carried out on the lightning struck panels using an R/D Tech Omniscan MX from Olympus. The scans showed that the white area of the modified panels were reduced in comparison to the unmodified panels of Example 16.

Therefore, the panels with metal coated particles has a much reduced damage area when compared to the comparative example 16 panels.

TABLE 12
Test parameters of lightning strike tests for Example 17.

| | A Component | Action | B Component | |
|---|---|---|---|---|
| Panel | Current, I | Integral, | current, I | C Component |
| No. | (kA) | AI (10⁶ A²s) | (kA) | Charge, Q |
| 1 | 197.1 | 2.20 | 1.74 | 25.0 |
| 2 | 195.7 | 2.10 | 1.75 | 29.3 |

TABLE 13
Description of damaged area after lightning
strike tests for Example 17.

| Panel | |
|---|---|
| No. | Description of Damage |
| 1 | No visible damage to inner skin, split & tufted |
| | over 280 × 240 mm on outer skin |
| 2 | No visible damage to inner skin, split & tufted |
| | over 280 × 220 mm on outer skin |

### EXAMPLE 18

### Simulated Lightning Strikes with Conductive Particles

M21 resin was modified with silver coated glass spheres (2 vol. %, 5 wt. % of resin) and carbon nanofibre (150 nm diameter and 1-10 μm long, 2 wt % of resin) blended using a Winkworth mixer and then filmed onto silicone release paper. This resin film was then impregnated onto unidirectional intermediate modulus carbon fibre which produced a prepreg with an areal weight of 268 g/m² at. 35 wt. % of resin. Two six-ply prepregs were produced (lay up ±0/90) which were approximately 60 cm by 60 cm and were cured on a vacuum table at a pressure of 7 bar at 177° C. for 2 hours. A lightning strike test was then carried out on each panel according to the method of Comparative Example 16.

The simulated lightning strikes did not penetrate the modified composite panels.

An Ultrasonic c-scan was carried out on the lightning struck modified panels using an R/D Tech Omniscan MX from Olympus. The scan showed that the white area of the modified panels was reduced in comparison to the unmodified panel of Comparative Example 16.

Therefore, the modified panels with metal coated particles and carbon nanofibres had a much reduced damage area When compared to the panels of Comparative Example 16.

TABLE 14
Test parameters of lightning strike tests for Example 18.

| | A Component | Action | B Component | |
|---|---|---|---|---|
| Panel | Current, I | Integral, | current, I | C Component |
| No. | (kA) | AI (10⁶ A²s) | (kA) | Charge, Q |
| 1 | 198.4 | 2.20 | 1.74 | 25.0 |
| 2 | 197.1 | 2.10 | 1.75 | 29.3 |

TABLE 15
Description of damaged area after lightning
strike tests for Example 18.

| Panel | |
|---|---|
| No. | Description of Damage |
| 1 | No visible damage to inner skin, 300 mm split, |
| | tufting over 300 × 200 mm on outer skin. |
| 2 | No visible damage to inner skin, 300 mm split, |
| | tufting over 200 × 200 mm on outer skin. |

It is therefore shown that use of electrically conductive particles in a polymeric resin of an interleafed composite material provides for reduced resistivity. This reduced resistivity provides improved performance of the composite material dining lightning strikes as shown in Comparative Example 16 and Examples 17 to 18.

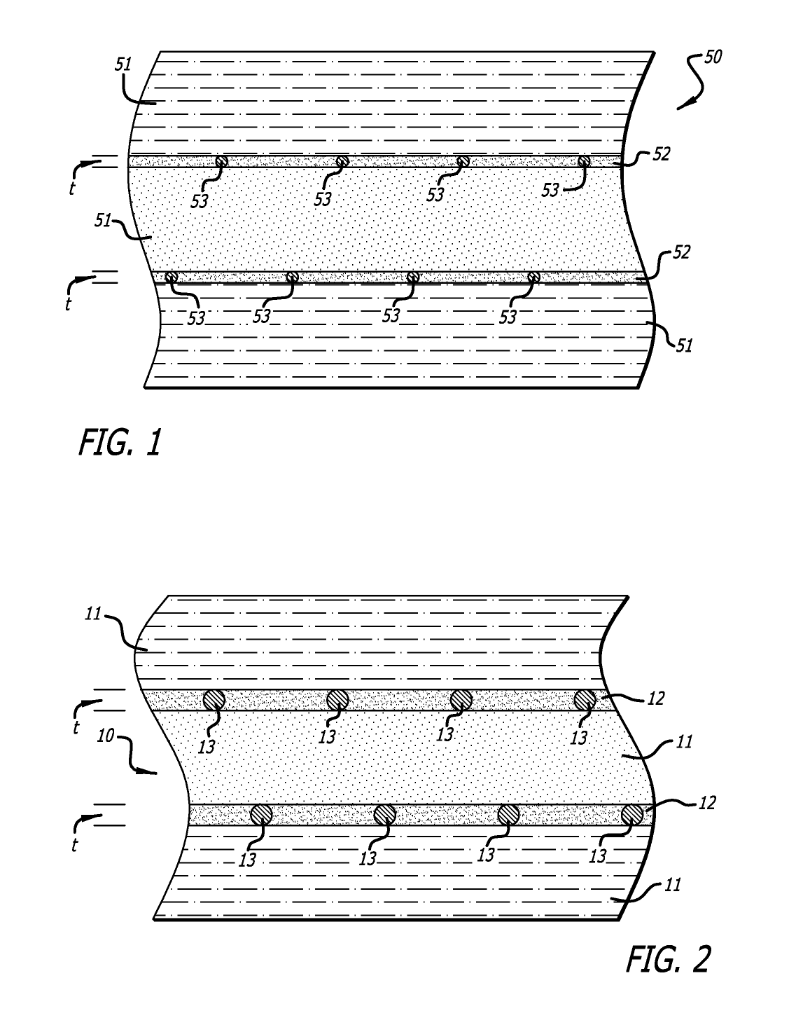

FIG. 1 is a simplified representation 50 of a photomicrograph of a cross section of a composite panel made according to Example 17. The silver coated glass spheres 53 are located in the resin interleafs 52, and are contacting the carbon plies 51. The thickness (t) of the resin interleafs 52 are 20 μm, which corresponds to the diameter of the silver coated glass spheres 53. As can be seen from FIG. 1, the glass microspheres form individual conductive bridges that electrically link the carbon plies 51 together and provide spacing between the carbon plies 51.

FIG. 2 is a simplified representation of the cross section of a portion of a composite material 10 made in accordance with Example 11. The silver coated glass spheres 13 are located in the resin interleafs 12 and are contacting the carbon plies 11. The thickness (t) of the resin interleafs 12 are 100 μm, which corresponds to the diameter of the silver coated glass spheres 13. As can also be seen from FIG. 2, the larger glass microspheres form individual conductive bridges that electrically link the carbon plies 11 together and provide spacing between the carbon plies 11.

The following description is directed to the alternate embodiment of the invention involving variable interleaf thickness.

The term “interleaf layer” as used herein in the context of a composite material according to the invention, can be equally taken to mean the sum of the thicknesses of the first and second outer resin layers at a given point of a prepreg according to the alternate embodiment of the present invention. Likewise, the term “average interleaf layer thickness” can be equally taken to mean the average of the sum of the thicknesses of the first and second outer resin layers at a given point of a prepreg according to the alternate embodiment of the present invention.

Accordingly, the interleaf layer (or the sum of the thicknesses of the first and second outer resin layer) has a thickness less than 50% of the average thickness in places and a thickness of greater than 120% of the average thickness in places. For example, if the average interleaf thickness is 30 micrometres, then the interleaf thickness varies over at least the range of from 15 to 36 micrometres.

Thus a prepreg with outer resin layers, and composite material with an interleaf layer, whose thickness is not constant but varies over a wide range of thicknesses as compared to the prior art is provided.

As discussed above, the composite material according to the invention is intended to be laid up with other composite material, to form a curable composite material stack.

Thus, the composite material according to the invention may include additional layers of unidirectional structural fibres, typically separated by interleaf resin layers. Such a stack may comprise from 4 to 200 layers of unidirectional structural fibres with most or all of the layers separated by a curable thermosetting resin interleaf layer. Suitable interleaf arrangements are disclosed in EP0274899.

Typically a plurality of the interleaf layers have a varying thickness according to the alternate embodiment of the present invention. In a preferred embodiment at least half of the interleaf layers have such a varying thickness. It may even be desirable for at least 75% of the interleaf layers to have such a varying thickness or even substantially all of the interleaf layers.

Additionally, typically a plurality of the structural layers will be electrically conducting, with preferably at least half being electrically conducting, more preferably at least 75% being electrically conducting, most preferably substantially all of them being electrically conducting.

It is believed that this variation in thickness provides the toughness properties to the composite material comparable to a composite material having a more regular thickness of interleaf layer. Furthermore, it is believed that the regions of low thickness allow conductive particles of smaller size to significantly or completely form an electrical connection between the two adjacent layers of electrically conductive fibres.

In a preferred embodiment the interleaf layer has a thickness that varies over at least the range of from 30% to 150% of the average thickness, more preferably over at least the range of from 15% to 175% of the average thickness, most preferably over at least the range of from 0% to 200% of the average thickness.

For the avoidance of doubt, throughout this specification, any lower value of a range may be combined with any upper value of a range without addition of subject matter.

For a material to be considered electrically conductive, it should have a volume resistivity of less than 3×10⁻⁵ Ωm, more preferably less than 1×10⁻⁷ Ωm, most preferably less than 3×10⁻⁸ Ωm.

The average interleaf layer thickness can be obtained by image analysis of sections through the composite material. Images of at least five slices through the composite material are to be taken and at least twenty interleaf thickness values made at evenly spaced distances, in order to generate a sample of the interleaf thickness. All of the values are then averaged by taking the mean to arrive at the average interleaf layer thickness. The minimum and maximum values sampled can be taken to provide the range over which the interleaf thickness varies. Preferably six slices are taken and 56 measurements taken every 300 microns. A similar analysis can be carried out for a prepreg according to the alternate embodiment of the present invention.

For the purposes of prepregs or composite materials in a structural application, it has been found that an average interleaf thickness in the range of from 15 to 60 micrometres is desirable to provide excellent mechanical performance. For example the average interleaf thickness may be in the range of from 20 to 40 micrometres.

As discussed above, the variation in the interleaf thickness allows for smaller particles to provide local regions of electrical conductivity. Thus, preferably the electrically conductive particles have a d50 average particle size of from 10% to 80% of the average interleaf layer thickness, preferably from 20% to 70% of the average interleaf layer thickness.

The electrically conductive particles may have a d50 average particle size of from 10 to 50 micrometres, more preferably from 10 to 25 micrometres, most preferably from 10 to 20 micrometres.

As it has been found that large electrically conductive particles can give rise to processing difficulties, it is preferred that the largest particles in any distribution are kept to a minimum. Thus, preferably the electrically conductive particles have a d90 of no greater than 40 micrometres, more preferably no greater than 30 micrometres, most preferably no greater than 25 micrometres.

Also as discussed above, as the particles are capable of providing electrical conductivity to the composite material by creating local regions of electrical conductivity in the interleaf, they do not need to be present at levels as high as would be necessary to increase the electrical conductivity of the whole of the interleaf layer. Thus, preferably the electrically conductive particles are present at a level of from 0.2 to 5.0 wt % based on the amount of resin matrix in the prepreg or composite material. Preferably the particles are present at from 0.3 to 2.0 wt %, more preferably from 0.4 to 1.5 wt %.

The electrically conductive particles may be made from a wide variety of conductive materials and may take a variety of forms. For example, they may comprise metal particles, metal-coated particles, conductive polymers or carbon particles. Suitable metals include silver, nickel and copper for example. However, preferably the electrically conductive particles comprise carbon particles, as it has been found that introducing metal into composite material can be undesirable due to the possibility of corrosion effects, explosion hazards and differences in the coefficient of thermal expansion of the materials.

Carbon comes in many forms, such as graphite flakes, graphite powders, graphite particles, graphene sheets, fullerenes, carbon black and carbon nanofibres and carbon nanotubes. However, only the glassy (or vitreous) carbon particles are suitable for use in the invention. Glassy carbon is typically non-graphitizable and is at least 70% sp2 bonded, preferably at least 80%, more preferably at least 90% and most preferably essentially 100% sp2 bonded.

Glassy carbon particles are very hard and do not disintegrate during blending operations with the resin. The glassy carbon particles have very low or zero porosity and are solid throughout and are not hollow. Hollow particles, although lighter, can compromise the mechanical properties of the composite by introducing voids.

Preferably the prepreg or composite material also comprises thermoplastic toughener particles. The thermoplastic particles provide toughness to the resulting laminate and can be made from a wide range of materials such as polyamides, copolyamides, polyimides, aramids, polyketones, polyetheretherketones, polyarylene ethers, polyesters, polyurethanes, polysulphones. Preferred materials include polyamide 6, polyamide 6/12, polyamide 11 and polyamide 12. The thermoplastic particles may be present in a wide range of levels, however it has been found that a level of from 5 to 20% based on the total resin in the composite material, preferably from 10 to 20% is preferred. Preferably the thermoplastic particles have a mean particle size of from 5 to 50 micrometres, preferably from 10 to 30 micrometres.

The prepreg and composite material of the present invention are predominantly composed of resin and structural fibres. Typically they comprise from 25 to 50 wt % of curable resin. Additionally they typically comprise from 45 to 75 wt % of structural fibres.

Typically the orientation of the unidirectional fibres will vary throughout the composite material, for example by arranging for unidirectional fibres in neighboring layers to be orthogonal to each other in a so-called 0/90 arrangement, signifying the angles between neighboring fibre layers. Other arrangements such as 0+45/−45/90 are of course possible, among many other arrangements.

The structural fibres may comprise cracked (i.e. stretch-broken), selectively discontinuous or continuous fibres. The structural fibres may be made from a wide variety of materials, such as carbon, graphite, metallised polymers, metal-coated fibres and mixtures thereof. Carbon fibres are preferred. Typically the fibres in the structural layer will generally have a circular or almost circular cross-section with a diameter in the range of from 2 to 20 μm, preferably from 3 to 12 μm.

The curable resin may be selected from epoxy, isocyanate and acid anhydride, cyanate esters, vinyl esters and benzoxazines for example. Preferably the curable resin is an epoxy resin. Suitable epoxy resins may comprise monofunctional, difunctional, trifunctional and/or tetrafunctional epoxy resins. Suitable difunctional epoxy resins, by way of example, include those based on; diglycidyl ether of bisphenol F, diglycidyl ether of bisphenol A (optionally brominated), phenol and cresol epoxy novolacs, glycidyl ethers of phenol-aldehyde adducts glycidyl ethers of aliphatic diols, diglycidyl ether, diethylene glycol diglycidyl ether, aromatic epoxy resins, aliphatic polyglycidyl ethers, epoxidised olefins, brominated resins, aromatic glycidyl amines, heterocyclic glycidyl imidines and amides, glycidyl ethers, fluorinated epoxy resins, glycidyl esters or any combination thereof.

Difunctional epoxy resins may be preferably selected from diglycidyl ether of bisphenol F, diglycidyl ether of bisphenol A, diglycidyl dihydroxy naphthalene, or any combination thereof.

Suitable trifunctional epoxy resins, by way of example, may include those based upon phenol and cresol epoxy novolacs, glycidyl ethers of phenol-aldehyde adducts, aromatic epoxy resins, aliphatic triglycidyl ethers, dialiphatic triglycidyl ethers, aliphatic polyglycidyl ethers, epoxidised olefins, brominated resins, triglycidyl aminophenyls, aromatic glycidyl amines, heterocyclic glycidyl imidines and amides, glycidyl ethers, fluorinated epoxy resins, or any combination thereof.

Suitable tetrafunctional epoxy resins include N,N,N′,N′-tetraglycidyl-m-xylenediamine (available commercially from Mitsubishi Gas Chemical Company under the name Tetrad-X, and as Erisys GA-240 from CVC Chemicals), and N,N,N′,N′-tetraglycidylmethylenedianiline (e.g. MY721 from Huntsman Advanced Materials).

The curable resin may also comprise one or more curing agents. Suitable curing agents include anhydrides, particularly polycarboxylic anhydrides; amines, particularly aromatic amines e.g. 1,3-diaminobenzene, 4,4′-diaminodiphenylmethane, and particularly the sulphones and methylene bisanilines, e.g. 4,4′-diaminodiphenyl sulphone (4,4′ DDS), and 3,3′-diaminodiphenyl sulphone (3,3′ DDS), 4,4′-methylenebis(2-methyl-6-isopropylaniline) (M-MIPA), 4,4′-methylenebis(3-chloro-2,6-diethylene aniline) (M-CDEA), 4,4′-methylenebis(2,6 diethyleneaniline) (M-DEA) and the phenol-formaldehyde resins. Preferred curing agents are the methylene bisanilines and the amino sulphones, particularly 4,4′ DDS and 3,3′ DDS.

Composite materials according to this alternate embodiment of the invention, as discussed above, is typically made by forming a laminate of a plurality of prepreg fibre layers. Each prepreg comprises a structured layer of electrically conductive fibres impregnated with curable resin matrix. Thus, steps must be taken in the manufacture of the prepregs to ensure that, when laminated together, a composite material according to the invention results.

It has been found that an effective way of achieving the variation in interleaf thickness is by employing a prepreg manufacturing method where the resin and electrically conductive particles are impregnated into the structural fibres at the same time, under conditions designed to give rise to controlled disruption of the unidirectional structural fibres.

Thus, in another aspect, this alternate embodiment of the invention relates to a process for the manufacture of a prepreg or composite material as herein defined comprising continuously feeding a layer of unidirectional conductive fibres, bringing into contact with a first face of the fibres a first layer of resin comprising curable resin and electrically conductive particles, and compressing the resin, conductive particles and fibres together sufficient for the resin to enter the interstices of the fibres and the resin being in sufficient amount for the resin to leave a first outer layer of resin essentially free of unidirectional conductive fibres, the first outer layer comprising the electrically conductive particles. The resulting prepreg can then be placed in contact with another prepreg to produce the composite material according to the invention.

Preferably a second layer of resin comprising curable resin is brought into contact with a second face of the fibres, typically at the same time as the first layer, compressing the first and second layers of resin together with the fibres such that resin enters the interstices of the fibres. In this case the second layer of resin may or may not comprise electrically conductive particles, as desired. However, preferably the second layer of resin does comprise electrically conductive particles. Such a process is considered to be a one-stage process because although each face of the fibres is contacted with one resin layer, all the resin in the eventual prepreg is impregnated in one stage. As two layers of resin are employed, this is sometimes referred to as a 2-film process.

Upon compression the resin is forced into the interstices and filtration of the electrically conductive particles occurs with compression forces such that the layer of structural fibres is partially disrupted.

Known interleaf prepregs are typically produced in a two stage process. The first stage bringing the fibres into contact with resin which enters the interstices, followed by bringing into contact with another resin which comprises particulate material, typically toughener particles. This second step is intended merely to lay down the resin including particulate material to produce a uniform layered prepreg. This two stage process is considered in the prior art to be desirable because it can produce well-ordered laminates with well defined layers of fibre and resin. Often the resin is carried on two layers in each step, resulting in four resin films in total. Thus, this process is sometimes referred to as a 4-film process.

It has been found that superior results are obtainable if impregnation of resin is carried out by passing the resin and fibres over one or more impregnation rollers wherein the pressure exerted onto the conductive fibres and resin does not exceed 40 kg per centimetre of the width of the conductive fibre layer. It is believed that high impregnation pressures conventional in the art, when applied to a one-stage process, induce too high a degree of disruption. Thus, the desired controlled disruption can arise by the combination of a one-stage impregnation process and the low pressures involved.

Resin impregnation typically involves passing the resin and fibres over rollers, which may be arranged in a variety of ways. Two primary arrangements are the simple “nip” and the “S-wrap” arrangements. An S-wrap stage is wherein the resin and fibres, both in sheet form pass around two separated rotating rollers in the shape of the letter “S”, known as S-wrap rollers. Alternative roller arrangements include the widely used “nip” wherein the fibre and resin are pinched, or nipped, together as they pass between the pinch point between two adjacent rotating rollers.

It is understood that S-wrap provides ideal conditions for reliable and reproducible impregnation of the resin between the interstices of the fibres whilst also providing sufficient disruption. However, nip stages are also possible, provided the pressures are kept low, e.g. by control over the gap between adjacent rollers.

It has been found that although large pressures in theory provide excellent resin impregnation, they can be detrimental to the outcome of the prepreg in the one-stage process according to the invention. It has been found that resin impregnation can be unreliable and fall outside required tolerances. Thus, the pressure exerted onto the conductive fibres and resin preferably does not exceed 40 kg per centimetre of width of the conductive fibre layer, more preferably does not exceed 35 kg per centimetre, more preferably does not exceed 30 kg per centimetre.

Following impregnation of resin into the fibres, often there is a cooling stage and further treatment stages such as laminating, slitting and separating. To facilitate impregnation of the resin into the fibres it is conventional for this to be carried out at an elevated temperature, e.g. from 60 to 150° C. preferably from 100 to 130° C., so that the resin viscosity reduces. This is most conveniently achieved by heating the resin and fibres, before impregnation, to the desired temperature, e.g. by passing them through an infra-red heater. As mentioned above, following impregnation there is typically a cooling step, to reduce the tackiness of the formed prepreg. This cooling step can be used to identify the end of the impregnation stage.

The impregnation rollers may rotate in a variety of ways. They may be freely rotating or driven. The impregnation rollers may be made from a wide variety of materials, although they typically have a metal exterior. Chrome finished rollers have been found to be preferable.

In order to improve handling of the resin it is conventional that it is supported onto a backing material, such as paper. The resin is then fed, typically from a roll, such that it comes into contact with the fibres, the backing material remaining in place on the exterior of the resin and fibre contact region. During the subsequent impregnation process the backing material provides a useful exterior material to apply pressure to, in order to achieve even impregnation of resin.

It has been found that when the backing material is compressible the forces produced by the impregnation process on the fibre layer are reduced. This is believed to be because compressible paper will become initially compressed during impregnation and only then will the forces from the impregnation process be transferred to the fibres. Thus, non-compressible paper is preferred because it increases the forces acting on the resin and fibres during impregnation, thus creating greater disruption of the fibres and better impregnation of the resin. A suitable measure of compressibility is the ratio of the thickness of the paper to its material density, called the compressibility ratio. It has been found that backing paper with a compressibility ratio of less than 0.001 kg⁻¹m⁻² are preferred.

For example, a glassine-based calendared or super-calendared differential silicone coated release paper that has a compressibility factor 0.00083 works well compared to another paper that is not calendared or super-calendared with a compressibility factor of 0.00127. Glassine based super-calendared papers are commercially available from many sources such as Mondi and Laufenberg.

Once formed, a plurality of such prepregs can be laid together to form a composite material according to this alternate embodiment of the present invention. The composite material according to this alternate embodiment of the invention is then typically cured by exposure to elevated temperatures and optionally elevated pressure to form a cured composite laminate. For example, curing may be carried out in an autoclave process of vacuum bag technique. Such a cured composite laminate is ideal for applications requiring good mechanical performance as well as electrical conductivity, such as in the aerospace industry. In particular they are ideal for use as a primary or secondary aircraft structural member, rocket or satellite casings etc.

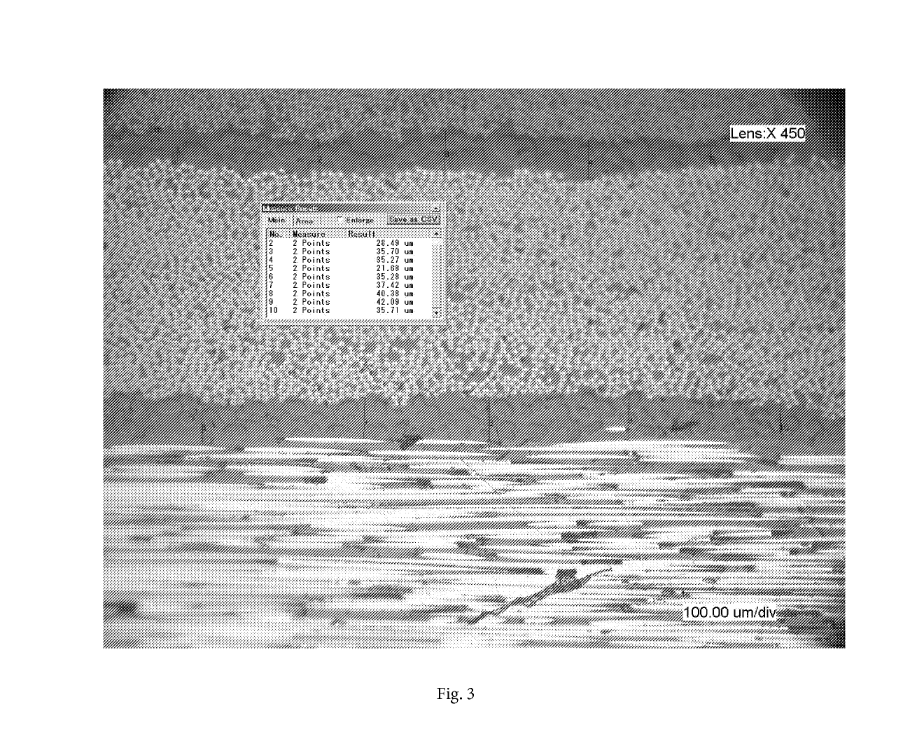

The alternate embodiment of the invention involving variable interleaf thickness will now be illustrated, by way of the following examples, and with reference to FIGS. 3-5.

### EXAMPLES

Prepregs (10 m×0.3 m) with different amounts of carbon microspheres were manufactured by feeding a continuous layer of unidirectional carbon fibres and bringing into contact with two layers of curable resin containing the electrically conductive particles and thermoplastic toughener particles (Orgasol from Arkema) in a so-called 2 film process.

The carbon microspheres (CMS) are manufactured by HTW of Germany and are called Sigradur G. Silver coated hollow glass beads (Ag Beads) were supplied Ecka Granules of the Netherlands. Resin formulations is as used in batches 1349 and 1351 of WO 2008/040963 apart from addition of the conductive particles which occurs at the same time as the Orgasol addition.

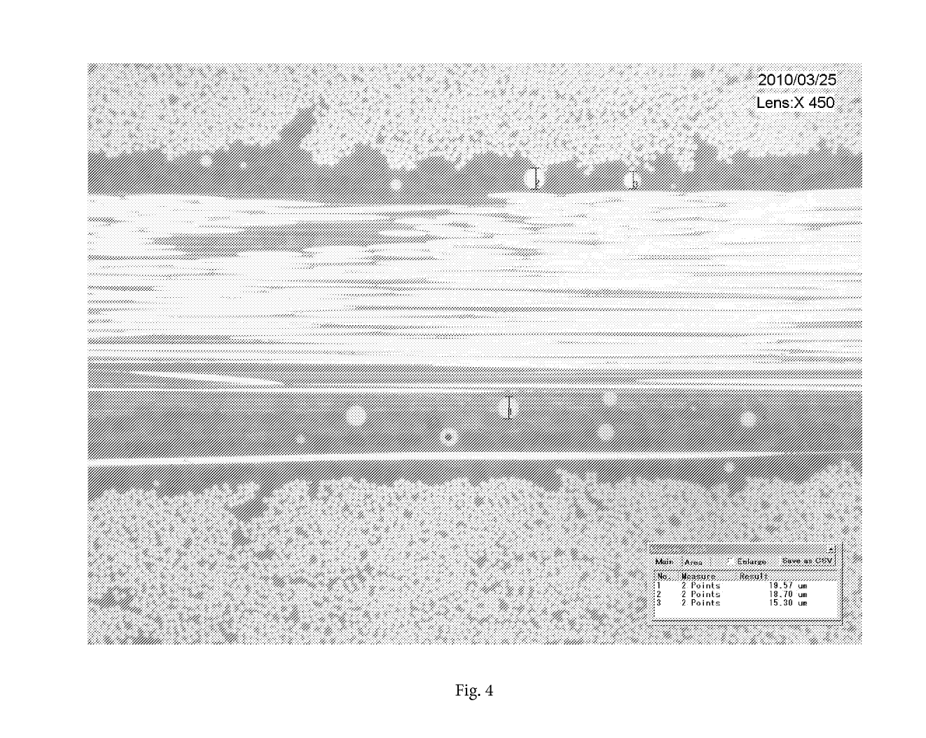

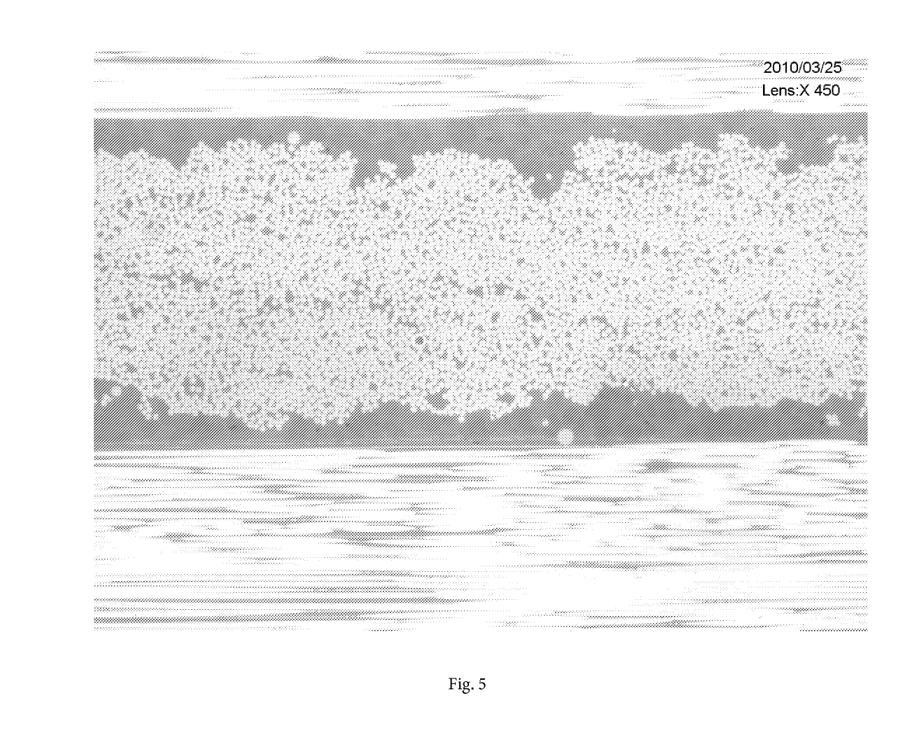

The prepreg was manufactured using IMA carbon fibre at an areal weight of 268 gsm. For resistance panels 12 ply laminates were produced using 0/90 lay-up and cured at 180° C. for 2 hours in an autoclave at 3 bar pressure. Due to the controlled disruption induced during resin impregnation, the interleaf thicknesses had an average value of about 25 micrometres and varied from 0 to 60 micrometres. Sample images of cross-sections through such laminates are shown in FIGS. 4 and 5.

For comparison, prepregs made by a 4-film process were also prepared. In this case, even interleaf thicknesses were obtained with an average thickness of about 40 micrometres and varied from 35 to 45 micrometres. A sample image of a cross-section through such a laminate is shown in FIG. 3.

Resistance of Composite Laminates Test Method

A panel is prepared by autoclave cure that is 300 mm×300 mm×3 mm in size. The lay-up of the panel is 0/90. Specimens (typically four to eight) for test are then cut from the panel that are 40 mm×40 mm. The square faces of the specimens should be sanded (for example on a on a Linisher machine) to expose the carbon fibres. This is not necessary if peel ply is used during the cure. Excess sanding should be avoided as this will penetrate past the first ply. The square faces are then coated with an electrically conductive metal, typically a thin layer of gold via a sputterer. Any gold or metal on the sides of the specimens should be removed by sanding prior to testing. The metal coating is required to ensure low contact resistance.

A power source (TTi EL302P programmable 30V/2 A power supply unit, Thurlby Thandar Instruments, Cambridge, UK) that is capable of varying both voltage and current is used to determine the resistance. The specimen is contacted with the electrodes (tinned copper braids) of the power source and held in place using a clamp (ensure electrodes do not touch each other or contact other metallic surfaces as this will give a false result). Ensure the damp has a non-conductive coating or layer to prevent an electrical path from one braid to the other. A current of one ampere is applied and the voltage noted. Using Ohm's Law resistance can then be calculated (V/I). The test is carried out on each of the cut specimens to give range of values. To ensure confidence in the test each specimen is tested two times.

Table 1 below shows resistance results of composite material comprising carbon and silver conductive particles at different loadings (as a % based on total resin content in the composite material).

TABLE 1

| | Through thickness |
|---|---|
| Panel description | resistance (Ohms) |
| 4 film | 5-50 |
| 2 film | 1-3 |
| 4 film + CMS(0.5%, 10-20 μm) | 4.30 |
| 2 film + CMS (0.5%, 10-20 μm) | 0.25-0.40 |
| 2 film + CMS (1.0%, 10-20 μm) | 0.21-0.26 |
| 2 film + CMS (1.5%, 10-20 μm) | 0.27 |
| 2 film + CMS (2.0%, 10-20 μm) | 0.25 |
| 2 film + CMS (3.0%, 10-20 μm) | 0.23 |
| 2 film + CMS (0.5%, 20-50 μm) | 0.35-0.56 |
| 2 film + Ag beads (0.5%, 10-40 μm) | 0.25 |
| 2 film + Ag beads (1.5%, 10-40 μm) | 0.14 |

It is to be noted that addition of 10-20 micron conductive particles does not have a significant impact of the electrical conductivity of the 4 film prepreg where the interleaf thickness is from 35 to 45 microns. However, the addition of 10-20 micron conductive particles significantly increases the electrical conductivity of the 2 film prepreg where the interleaf thickness is from 0 to 60 microns.

All the conductive additives lower the resistance values of 2 film with the best result being achieved for the silver coated hollow glass beads at 1.5 wt %. Acceptable results are still achieved with the CMS (10-20 μm) but loading with greater than 1 wt % does not decrease resistance further. Furthermore, this effect is observed at very low levels of conductive particle, down as low as 0.5 wt % based on the amount of resin.

Mechanical Performance

A further 100 metres of CMS 0.5%, 10-20 μm and 20-50 μm prepreg was manufactured on the production line and resistance and mechanicals determined. Mechanicals were comparable to standard laminates without the conductive particles. A cured ply thickness of 0.25 mm was assumed for the 268 gsm fibre areal weight (faw) fibres. A cured ply thickness of 0.184 mm was assumed for the 194 gsm fibre areal weight (faw) fibres.

TABLE 2

| | 2 film CMS | 2 film CMS | |
|---|---|---|---|
| | (10-20) | (20-50) | 2 film |
| Test | 268 gsm faw | 268 gsm faw | 268 gsm faw |
| 0°-tensile strength | 2690 | 2797 | 3041 |
| MPa (ASTM D3039) | | | |
| 0°-tensile modulus | 187.2 | 190.4 | 184 |
| GPa (ASTM D3039) | | | |
| OHT strength | 749 | 761.2 | 788 |
| (directed | | | |
| 40/40/20) MPa | | | |
| (ASTM D5766) | | | |
| CAI -30J impact | 265.5 | 269 | 269 |
| MPa (ASTM D7137) | | | |
| IPS strength MPa | 99 | 93 | 74 |
| (ASTM D3518) | | | |
| IPS Modulus GPa | 5.3 | 5.4 | 5.5 |
| (ASTM D3518) | | | |

TABLE 3

| | 2 film | 2 film | |
|---|---|---|---|
| | (10-20) | (20-50) | 4 film |
| Test | 194 gsm faw | 194 gsm | 194 gsm faw |
| 0°-tensile strength | 2850 | 2729 | 3312 |
| MPa (ASTM D3039) | | | |
| 0°-tensile modulus | 183.6 | 179.6 | 183.5 |
| GPa (ASTM D3039) | | | |
| OHT strength | 972.6 | 954 | 971 |
| (directed | | | |
| 40/40/20) MPa | | | |
| (ASTM D5766) | | | |
| CAI -30J impact | 258 | 259 | 241-299 |
| MPa (ASTM D7137) | | | |
| IPS strength MPa | 115 | 117 | 115.9 |
| (ASTM D3518) | | | |
| IPS Modulus GPa | 5.5 | 5.3 | 5.5 |
| (ASTM D3518) | | | |

It can be seen that the variable thickness in the interleaf thickness does not negatively impact the mechanical properties. Additionally the presence of the electrically conductive carbon particles has no effect on mechanical performance either.

Interleaf Thickness Calculation

Six specimens were cut from a cured panel obtained from the above examples and the interleaf thickness was measured (in micrometres) for each specimen every 300 microns. Measurements for each specimen were taken along one interleaf. In the table below is listed the measured individual interleaf layer thickness.

TABLE 4

| Sample No. | Spec 1 | Spec 2 | Spec 3 | Spec 4 | Spec 5 | Spec 6 |
|---|---|---|---|---|---|---|
| 1 | 67.7 | 8.9 | 32.8 | 7.2 | 34.9 | 17.4 |
| 2 | 31.9 | 30.2 | 28.9 | 29.8 | 45.5 | 22.1 |
| 3 | 30.6 | 13.2 | 23 | 5.1 | 32.8 | 28.9 |
| 4 | 25.1 | 10.2 | 22.1 | 6.8 | 30.6 | 32.3 |
| 5 | 14.9 | 17.4 | 28.9 | 6.4 | 28.1 | 18.3 |
| 6 | 9.8 | 8.1 | 21.3 | 8.9 | 10.6 | 23.4 |
| 7 | 14 | 11.1 | 20.4 | 0 | 33.6 | 11.1 |
| 8 | 27.6 | 23.8 | 53.6 | 37 | 34 | 17 |
| 9 | 37.4 | 59.5 | 58.7 | 29.3 | 19.6 | 57.8 |
| 10 | 5.1 | 30.2 | 53.6 | 37 | 6.8 | 54.4 |
| 11 | 3 | 28.1 | 51 | 35.7 | 9.4 | 31 |
| 12 | 1 | 29.3 | 44.2 | 25.9 | 16.2 | 26.4 |
| 13 | 0 | 39.5 | 31.5 | 29.3 | 10.6 | 27.6 |
| 14 | 9.8 | 48.5 | 21.7 | 25.5 | 37.8 | 23.8 |
| 15 | 14.5 | 40.4 | 15.4 | 17.4 | 19.6 | 29.8 |
| 16 | 9.4 | 27.2 | 12.3 | 20.8 | 19.1 | 40.8 |
| 17 | 0 | 20 | 15.3 | 40.4 | 27.6 | 36.6 |
| 18 | 5.1 | 14 | 4.7 | 15.3 | 25.5 | 43.8 |
| 19 | 22.6 | 28.5 | 11.1 | 30.6 | 28.9 | 19.1 |
| 20 | 16.2 | 25.1 | 29.3 | 30.2 | 14.9 | 11.1 |
| 21 | 36.6 | 43.8 | 30.6 | 31 | 29.3 | 34.4 |
| 22 | 25.5 | 17.4 | 12.8 | 8.1 | 43.4 | 22.5 |
| 23 | 41.2 | 26.8 | 14 | 17.9 | 38.7 | 21.7 |
| 24 | 20.4 | 20.2 | 11.5 | 30.6 | 16.2 | 13.6 |
| 25 | 20.8 | 10.7 | 18.3 | 19.1 | 19.6 | 12.8 |
| 26 | 21.3 | 14.9 | 4.7 | 11.5 | 19.6 | 7.7 |
| 27 | 20.4 | 18.3 | 13.6 | 22.1 | 50.6 | 16.6 |
| 28 | 9 | 18.7 | 16.6 | 37 | 43.8 | 34 |
| 29 | 31.6 | 40.8 | 21.3 | 21.7 | 32.3 | 9.8 |
| 30 | 28.1 | 17.4 | 25.1 | 21.7 | 28.1 | 6 |
| 31 | 28.1 | 24.2 | 16.2 | 29.4 | 32.8 | 5.1 |
| 32 | 43.8 | 28.1 | 35.8 | 16.6 | 48.9 | 30.6 |
| 33 | 46.3 | 22.5 | 32.3 | 17 | 37.8 | 24.7 |
| 34 | 32.7 | 23 | 7.2 | 13.2 | 25.5 | 37.4 |
| 35 | 34.9 | 0 | 24.2 | 33.2 | 21.7 | 28.5 |
| 36 | 34 | 17.9 | 43 | 0 | 37 | 40 |
| 37 | 33.2 | 23.8 | 37 | 0 | 28.1 | 13.2 |
| 38 | 23.4 | 21.3 | 15.7 | 59.5 | 26.8 | 24.2 |
| 39 | 32.3 | 6 | 12.8 | 31.5 | 20.4 | 28.5 |
| 40 | 38.7 | 12.8 | 4.3 | 23 | 30.2 | 29.3 |
| 41 | 26.2 | 23.8 | 20.4 | 15.3 | 35.3 | 11.9 |
| 42 | 28.9 | 25.9 | 14 | 25.1 | 18.7 | 6 |
| 43 | 18.3 | 21.7 | 8.1 | 25.9 | 11.9 | 10.2 |
| 44 | 21.7 | 22.5 | 31 | 13.2 | 58.7 | 6.8 |
| 45 | 57.8 | 24.2 | 28.5 | 17.4 | 45.1 | 9.8 |
| 46 | 22.5 | 8.9 | 16.6 | 31 | 38.7 | 32.7 |
| 47 | 31.9 | 17.4 | 34.9 | 24.9 | 38.3 | 37.8 |
| 48 | 24.2 | 22.1 | 34 | 25.5 | 42.5 | 28.1 |
| 49 | 15.3 | 23 | 32.3 | 11.1 | 27.6 | 18.7 |
| 50 | 11.5 | 17.9 | 62.5 | 36.1 | 0 | 26.8 |
| 51 | 45.1 | 20.4 | 29.8 | 32.3 | 21.7 | 65.5 |
| 52 | 21.7 | 13.6 | 31.5 | 41.7 | 15.3 | 35.3 |
| 53 | — | 30.2 | 17.9 | 17.9 | 11.5 | 37.5 |
| 54 | — | 21.3 | 17.9 | 17.9 | 27.3 | 29.8 |
| 55 | — | 7.2 | 6.8 | 35.7 | 7.2 | 18.7 |
| 56 | — | 24.2 | 18.3 | 28.5 | 17.4 | 14.5 |

The composite material therefore has an average interleaf layer thickness of 24.5 micrometres, with the thickness varying over the range of from 0 to 67.7 micrometres i.e. from 0% to 276% of the average interleaf layer thickness.

Having thus described exemplary embodiments of the present invention, it should be noted by those skilled in the art that the within disclosures are exemplary only and that various other alternatives, adaptations and modifications may be made within the scope of the present invention. Accordingly, the present invention is not limited by the above-described embodiments, but is only limited by the following claims.

What is claimed is:

1. A composite material comprising:
a. first structural layer comprising a first surface comprising electrically conductive unidirectional fibres;
a second structural layer comprising a second surface comprising electrically conductive unidirectional fibres; and
an interleaf layer which separated the first and second surfaces, said interleaf layer comprising curable resin wherein the thickness of said interleaf layer is the distance at any given point between the electrically conductive unidirectional fibres at said first surface and the electrically conductive fibres at said second surface and wherein the average thickness of said interleaf layer ranges from 15 micrometres to 60 micrometres, wherein the thickness of said interleaf varies over the range of at least 50% to 120% of the average interleaf layer thickness at another given point, and wherein the interleaf layer comprises electrically conductive particles, said conductive particles having a d50 average particle size of from 10% to 80% of the average thickness of said interleaf laver.

2. A composite material according to claim 1, which comprises further layers of unidirectional structural fibres and interleaf resin layers wherein at least half of the interleaf layers are as defined in claim 1.

3. A composite material according to claim 2, wherein at least half of the unidirectional structural layers are electrically conducting.

4. A composite material according to claim 1 wherein the electrically conductive particles are present in an amount of from 0.4 wt % to 1.5 wt %, based on the total weight of said curable resin.

5. A composite material according to claim 1, wherein said interleaf varies over the range of at least 30% to 150% of the average interleaf layer thickness at another given point.

6. A composite material according to claim 1, wherein said interleaf varies over the range of at least 0% to 200% of the average interleaf layer thickness at another given point.

7. A composite material according to claim 1, wherein the electrically conductive particles have a d50 average particle size of from 10 to 30 micrometres.

8. A composite material according to claim 1, wherein the electrically conductive particles have a d90 of no greater than 40 micrometres.

9. A composite material according to claim 1, wherein the electrically conductive particles have a d90 of no greater than 25 micrometres.

10. A composite material according to claim 1, wherein the electrically conductive particles comprise carbon particles.

11. A cured composite material obtainable by the process of curing a composite material according to claim 1.

12. A cured composite laminate according to claim 11, which is for use as an aerospace structural member.

13. A composite material according to claim 1 wherein said first and second surfaces comprise electrically conductive unidirectional fibres that have a diameters in the range of 2 to 20 micrometres.

14. A composite material according to claim 1 wherein said conductive particles having a d50 average particle size of from 20% to 70% of the average thickness of said interleaf layer.

15. A composite material according to claim 1 wherein said curable resin comprises thermoplastic particles.

16. A composite material according to claim 15 wherein said thermoplastic particles are polyamide particles.

17. A composite material according to claim 15, wherein said thermoplastic particles are present at a level of from 5 to 20 wt % based on the total weight of said curable resin.

18. A composite material according to claim 10, wherein said carbon particles are glassy carbon particles.

19. A composite material according to claim 1 wherein the average thickness of said interleaf is 25 micrometres and said conductive particles are carbon microspheres that range in size from 10 micrometres to 20 micrometres.

20. A composite material according to claim 19 wherein said conductive particles are present in an amount of 0.5 wt % or 1.0 wt %, based on the total weight of said curable resin.
